(19) United States
(12) Patent Application Publication
(10) Pub. No.: US 2026/0281437 A1
(43) Pub. Date: Sep. 17, 2026

(54) DATA PROCESSING METHOD AND DEVICE

(71) Applicant: Tencent Technology (Shenzhen) Company Limited, Shenzhen (CN)

(72) Inventors: Yingbin WANG, Shenzhen (CN); Xiaozhong XU, Shenzhen (CN)

(73) Assignee: Tencent Technology (Shenzhen) Company Limited, Shenzhen (CN)

(21) Appl. No.: 19/674,091

(22) Filed: May 11, 2026

Related U.S. Application Data
(63) Continuation of application No. PCT/CN2024/131363, filed on Nov. 11, 2024.

(30) Foreign Application Priority Data
Dec. 12, 2023 (CN) 202311709214.1

(51) Int. Cl. H04N 19/60; H04N 19/105; H04N 19/159; H04N 19/176; H04N 19/46; H04N 19/70

(52) U.S. Cl. CPC H04N 19/60; H04N 19/105; H04N 19/159; H04N 19/176; H04N 19/46; H04N 19/70

(57) ABSTRACT

Aspects of this disclosure provide a video decoding method and a video encoding method. In a video decoding method, a coded bitstream of a video is obtained. The coded bitstream includes transform mode syntax control information of a secondary transform mode. The secondary transform mode is determined from a plurality of secondary transform modes based on the transform mode syntax control information. A current block of a current picture of the video is decoded with the secondary transform mode that is determined based on the transform mode syntax control information. The transform mode syntax control information indicates which of the plurality of secondary transform modes is enabled for the current block. Apparatus and non-transitory computer-readable storage medium counterpart embodiments are also contemplated.

### RELATED APPLICATIONS

The present application is a continuation of International Application No. PCT/CN2024/131363, filed on Nov. 11, 2024, which claims priority to Chinese Patent Application No. 202311709214.1, filed on Dec. 12, 2023. The entire disclosures of the prior applications are hereby incorporated by reference.

### FIELD OF THE TECHNOLOGY

This disclosure relates to the field of computer technologies, including data processing methods, data processing apparatuses, computer devices, and computer-readable storage media.

### BACKGROUND OF THE DISCLOSURE

With development of computer technologies, various types of media content are generated, including but not limited to, videos, audios, pictures, and the like. For better transmission and storage of these types of media content, many audio and video coding standards are proposed for coding and decoding, to implement compression and decompression of these types of media content. Currently, many transform tools are introduced to the video coding standards to improve decoding performance, but use of the transform tools is subject to fixed control. Based on different transform requirements of videos in different scenarios, a fixed transform mode cannot improve the performance desirably. On the contrary, coding/decoding time may be increased, affecting coding/decoding efficiency.

### SUMMARY

Aspects of this disclosure provide data processing methods and devices, to flexibly control the use of a transform mode, thereby improving coding/decoding efficiency.

According to an aspect, this disclosure provides a video decoding method. In the method, a coded bitstream of a video is obtained. The coded bitstream includes transform mode syntax control information of a secondary transform mode. The secondary transform mode is determined from a plurality of secondary transform modes based on the transform mode syntax control information. A current block of a current picture of the video is decoded with the secondary transform mode that is determined based on the transform mode syntax control information. The transform mode syntax control information indicates which of the plurality of secondary transform modes is enabled for the current block.

According to an aspect, this disclosure provides a video encoding method. In the method, a secondary transform mode is determined from a plurality of secondary transform mode. Transform mode syntax control information of a video that indicates the secondary transform mode is generated. A current block of a current picture of the video is encoded with the secondary transform mode. The transform mode syntax control information is encoded into a coded bitstream of the video. The transform mode syntax control information indicates which of the plurality of secondary transform modes is enabled for the current block.

According to an aspect, this disclosure provides a video decoding apparatus. The apparatus includes processing circuitry configured to obtain a coded bitstream of a video. The coded bitstream includes transform mode syntax control information of a secondary transform mode. The processing circuitry is configured to determine the secondary transform mode from a plurality of secondary transform modes based on the transform mode syntax control information. The processing circuitry is configured to decode a current block of a current picture of the video with the secondary transform mode that is determined based on the transform mode syntax control information. The transform mode syntax control information indicates which of the plurality of secondary transform modes is enabled for the current block.

According to an aspect, this disclosure provides a first data processing method. The first data processing method includes: obtaining a coded bitstream of a video, the coded bitstream including transform mode syntax control information, and the transform mode syntax control information being configured for controlling use of a transform mode; decoding the coded bitstream; and controlling the use of the transform mode according to the transform mode syntax control information in a decoding process.

In this aspect, the coded bitstream of the video may be obtained. The coded bitstream includes the transform mode syntax control information, and the transform mode syntax control information is configured for controlling the use of the transform mode. It can be learned that the use of the transform mode in the decoding process can be flexibly controlled by using the transform mode syntax control information by adding the transform mode syntax control information to the coded bitstream, thereby effectively guiding a transform procedure in the decoding process. The coded bitstream is decoded, and the use of the transform mode is controlled according to the transform mode syntax control information in the decoding process. In this mode, the use of the transform mode can be flexibly controlled based on the transform mode syntax control information in the coded bitstream in the decoding process, thereby improving coding/decoding efficiency.

According to an aspect, this disclosure provides a second data processing method. The second data processing method includes: determining transform mode syntax control information that needs to be used for a video, the transform mode syntax control information being configured for controlling use of a transform mode; coding the video; and coding the transform mode syntax control information into a coded bitstream of the video in a coding process.

In this aspect, the transform mode syntax control information is determined for the video, and the transform mode syntax control information is coded into the coded bitstream, to accurately indicate the use of the transform mode to a decoder side. A transform mode of a corresponding type can be adaptively enabled or disabled in different scenarios by using the transform mode syntax control information, so that the use of the transform mode in a corresponding scenario is flexibly and appropriately controlled. This is beneficial to improving video coding performance.

According to an aspect, this disclosure provides a data processing apparatus. The apparatus includes: an obtaining unit, configured to obtain a coded bitstream of a video, the coded bitstream including transform mode syntax control information, and the transform mode syntax control information being configured for controlling use of a transform mode; and a processing unit, configured to decode the coded bitstream.

The processing unit is further configured to control the use of the transform mode according to the transform mode syntax control information in a decoding process.

According to an aspect, this disclosure provides another data processing apparatus. The apparatus includes: a determining unit, configured to determine transform mode syntax control information that needs to be used for a video, the transform mode syntax control information being configured for controlling use of a transform mode; and a processing unit, configured to code the video.

The processing unit is further configured to code the transform mode syntax control information into a coded bitstream of the video in a coding process.

According to an aspect, this disclosure provides a computer device. The computer device includes: processing circuitry (e.g., a processor), configured to execute a computer program; and a computer-readable storage medium (e.g., a non-transitory computer-readable storage medium), the computer-readable storage medium storing the computer program, and the foregoing data processing methods being implemented when the computer program is executed by the processor.

According to an aspect, this disclosure provides a computer-readable storage medium (e.g., a non-transitory computer-readable storage medium). The computer-readable storage medium stores a computer program, and the computer program is loaded by a processor to perform the foregoing data processing methods.

According to an aspect, this disclosure provides a computer program product. The computer program product includes a computer program or computer instructions, and the foregoing data processing methods are implemented when the computer program or the computer instructions are executed by a processor.

According to an aspect, this disclosure provides a method for processing a video bitstream. The video bitstream is generated according to the foregoing second data processing method or video encoding method, or is decoded according to the foregoing first data processing method or video decoding method.

### BRIEF DESCRIPTION OF THE DRAWINGS

FIG. 1a is a schematic flowchart of video coding according to an aspect of this disclosure.

FIG. 1b is a schematic diagram of coefficient flipping according to an aspect of this disclosure.

FIG. 1c is a schematic diagram of partition of a coding unit (CU) according to an aspect of this disclosure.

FIG. 1d is a schematic diagram of a transform type of a sub-block transform according to an aspect of this disclosure.

FIG. 1e is a schematic diagram of content of a secondary transform kernel according to an aspect of this disclosure.

FIG. 2 is a diagram of an architecture of a data processing system according to an aspect of this disclosure.

FIG. 3 is a schematic flowchart of a data processing method according to an aspect of this disclosure.

FIG. 4a is a schematic diagram of a structure of a video sequence according to an aspect of this disclosure.

FIG. 4b is a schematic diagram of a slice structure according to an aspect of this disclosure.

FIG. 4c is a schematic diagram of a relationship between syntax structures according to an aspect of this disclosure.

FIG. 5 is a schematic flowchart of another data processing method according to an aspect of this disclosure.

FIG. 6a is a schematic diagram of a structure of a data processing apparatus according to an aspect of this disclosure.

FIG. 6b is a schematic diagram of a structure of another data processing apparatus according to an aspect of this disclosure.

FIG. 7 is a schematic diagram of a structure of a computer device according to an aspect of this disclosure.

### DETAILED DESCRIPTION

Descriptions of terms in this disclosure are provided as examples only and are not intended to limit the scope of the disclosure. In this disclosure, the terms such as “first” and “second” may be used for distinguishing between same items or similar items with substantially same effects and functions. There is no dependency relationship between “first”, “second”, and “n^{th}” in terms of logic or a time sequence, and a quantity and an execution sequence are not limited. In this disclosure, the term “at least one” means one or more, and “multiple” means two or more. For example, at least one syntax element may refer to one or more syntax elements.

In this disclosure, the term “at least one” means one or more, and “a plurality of” means two or more. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

To help understand the technical solutions provided in this disclosure, a video coding procedure related to a video coding technology is first described below.

According to signal obtaining modes, video signals may include a video shot by a camera and a video generated by a computer. The video shot by the camera is natural content captured by the camera. The video generated by the computer is a type of screen content. In brief, the screen content is a text, a picture, an animation, a video, or the like generated by the computer. For example, a screen sharing picture, a cloud game picture, a video conference picture, and the like are all screen content. Statistical characteristics of signal distribution of the screen content generated by the computer greatly differ from those of the natural content captured by the camera in terms of distortion sensitivity to human eyes. For example, compared with the video shot by the camera, the video as the screen content may have a larger flat region, less noise, more repeated patterns and characters, more-limited color types, higher picture contrast, and a sharper edge. Therefore, based on the different statistical characteristics, the video shot by the camera and the video generated by the computer may correspond to different compression coding schemes. For example, for the video shot by the camera, compression coding is usually performed by using the High Efficiency Video Coding (HEVC, an international video coding standard, which may also be referred to as H.265), the Versatile Video Coding (VVC, an international video coding standard, which may also be referred to as H.266), or the like. For the video generated by the computer, a video coding standard supporting a screen content coding (SCC) function is usually used, including but not limited to: HEVC-SCC (for example, a video coding standard supporting the SCC), the Alliance for Open Media Video 1 (AV1, a 1^{st}-generation video coding standard formulated by the Alliance for Open Media (AOM)), the Alliance for Open Media Video 2 (AV2, a 2^{nd}-generation video coding standard formulated by AOM), the Audio Video coding Standard 3 (AVS3, an audio video coding standard), and the like.

HEVC, VVC, and AVS3 mentioned above use a hybrid coding framework. The hybrid coding framework is a video coding technology that combines multiple coding methods (such as predictive coding, transform & quantization, and entropy coding) to improve video compression efficiency and picture quality. When compression coding is performed on an inputted original video signal by using the foregoing video coding technology, the following operations and processing are for example included:

(1) Block partition structure: An inputted picture may be partitioned into multiple non-overlapping processing units according to the size of one unit, and a similar compression operation is performed on each processing unit. The processing unit is referred to as a coding tree unit (CTU, which may also be referred to as a largest CU) or an LCU (a largest CU in HEVC). The CTU may be further partitioned more finely to obtain one or more basic units of coding, referred to as one or more CUs. Each CU is a most basic element in a coding process. The following describes various coding schemes that may be used for each CU.

(2) Predictive coding: includes intra (picture) prediction, inter (picture) prediction, and the like. In the intra prediction mode, a predicted signal is from a coded and reconstructed region in a same picture. In the inter prediction mode, a predicted signal is from another coded picture (referred to as a reference picture) different from a current picture. A residual video signal is obtained after the original video signal is predicted by using a selected reconstructed video signal. A coder side may select an appropriate predictive coding mode for a current CU from multiple predictive coding modes, and notify a decoder side of the predictive coding mode.

(3) Transform & quantization: A transform operation, for example, a discrete Fourier transform (DFT) or a discrete Cosine transform (DCT), is performed on the residual video signal, to convert the video signal into a transform domain to obtain a transform coefficient (for example, a DC coefficient). In an implementation, a secondary transform may be performed on the transform coefficient, to improve transform efficiency and improve overall performance of a coder. The secondary transform means performing a 2^{nd} transform on a frequency domain signal (a primary transform coefficient) after a primary transform, to convert the signal from one transform domain to another transform domain. The primary transform is a transform that is first applied in a coding process, and the secondary transform is a transform that is applied after the primary transform, and is usually applied to further optimize a coding effect. Rationality of the secondary transform lies in: The DC coefficient (the primary transform coefficient) usually has high statistical redundancy, a magnitude of the DC coefficient is usually large, and costs for entropy coding are high. The redundancy can be further reduced through the secondary transform, to achieve better performance. A lossy quantization operation is performed on a signal in a transform domain, and some information is lost, so that a quantized signal is conducive to compressed expression. Quantization fineness may depend on a quantization parameter (QP). A larger value of the QP indicates that coefficients within a larger value range are quantized to a same output. Therefore, larger distortion and a lower bit rate are usually caused. In contrast, a smaller value of the QP indicates that coefficients within a smaller value range are quantized to a same output. Therefore, smaller distortion and a higher bit rate are usually caused. In some video coding standards, multiple transform modes (which may also be referred to as transform methods) may be selected. Therefore, the coder side may select one transform mode from the transform modes for the current CU, and notify the decoder side of the transform mode.

(4) Entropy Coding or statistical coding: Statistical compression coding may be performed on a quantized transform-domain signal according to frequency of occurrence of values, and finally, a binarized (0 or 1) compressed bitstream is outputted. In addition, entropy coding also needs to be performed on other information (such as the selected mode and a motion vector) generated through coding, to reduce a bit rate. The statistical coding is a lossless coding mode, which can effectively reduce a bit rate required to express a same signal. Common statistical coding modes include variable length coding (VLC) or content adaptive binary arithmetic coding (CABAC).

(5) In-loop filtering: A decoded reconstructed picture can be obtained by performing scaling & an inverse transform (inv. transform), and prediction compensation (inverse operations of (2) to (4)) on a coded picture. Due to impact of quantization, some information in the reconstructed picture is different from that in the original picture, resulting in distortion. The distortion caused by the quantization can be effectively reduced by performing a filtering operation on the reconstructed picture by using, for example, a deblocking filter, a sample adaptive offset (SAO) filter, or an adaptive loop filter (ALF). Because these filtered reconstructed pictures are used as references for subsequent picture coding to predict future signals, the foregoing filtering operation is also referred to as the in-loop filtering, for example, a filtering operation in a coding loop.

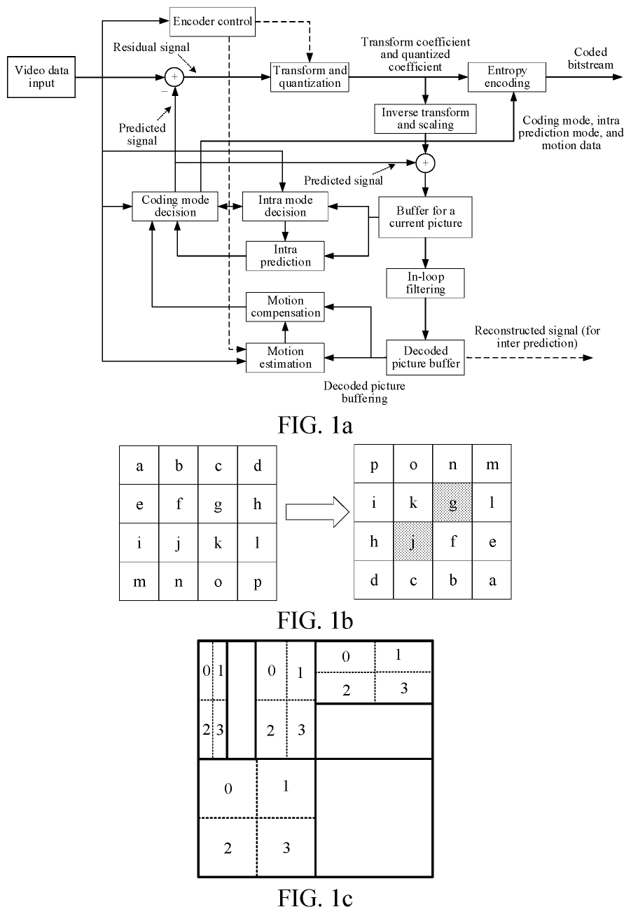

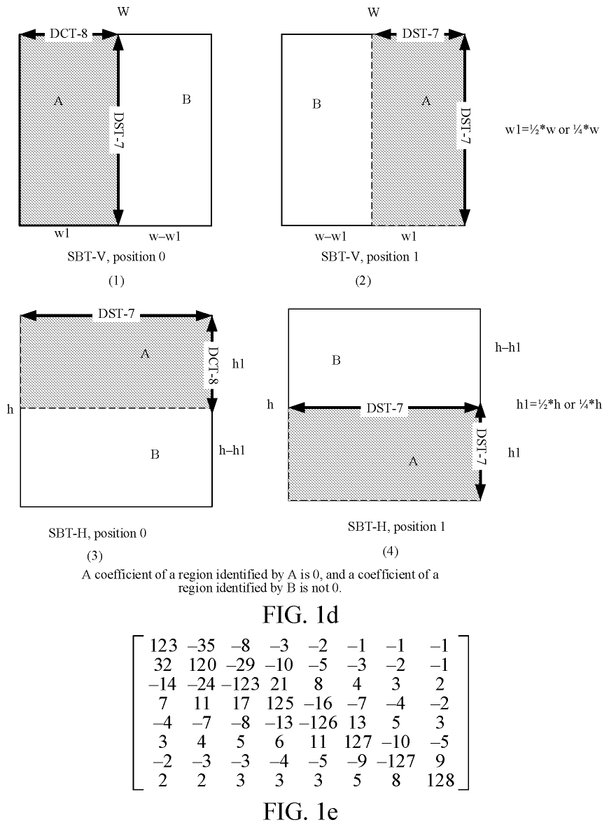

The operations and processing described in (1) to (5) may be performed by a video coder, and FIG. 1a is an example of a basic diagram of a procedure for video coding. The basic procedure may include: Video data is inputted (that is, a video picture is inputted) to the video coder, where the video picture may be inputted in a coding order and partitioned into blocks. For a current coding block (for example, a CU that is being coded) in the video picture, whether a predictive coding mode is the intra-picture prediction mode or the inter-picture prediction mode (for example, motion-compensation prediction) may be determined through an intra mode decision and motion estimation, to notify a coding mode decision module of information about the predictive coding mode. Predictive coding may be performed on the current coding block in the determined predictive coding mode, to obtain a predicted signal. Furthermore, the coding mode decision module may perform entropy coding on related information (including the coding mode, the intra prediction mode, and motion data) for coding into a coded bitstream. A residual signal may be computed based on the predicted signal and a current coding signal. After sequentially undergoing a transform & quantization, the residual signal sequentially undergoes scaling & an inv. transform, and is combined with the predicted signal, to obtain a reconstructed signal. The reconstructed signal may be stored in a buffer for the current picture as a reference for intra prediction. After in-loop filtering, the reconstructed signal may be stored in a decoding buffer, so that a buffered picture (in a decoded picture buffer) can be subsequently obtained through decoding during inter prediction and used as a reference for motion estimation (a reconstructed video (for motioning)). In this way, after entropy coding is performed on the reconstructed signal, the coded bitstream may be obtained. The transform & quantization and the motion estimation may be controlled by an encoder controller. The terms “coded bitstream”, “decoded bitstream”, “compressed bitstream”, and “bitstream” in this disclosure are equivalent unless otherwise specified.

According to the foregoing coding process, correspondingly, on the decoder side and for each CU, after obtaining the coded bitstream, a decoder first performs entropy decoding, to obtain various coding mode information and quantized transform coefficients. On one hand, scaling & an inv. transform are performed on each quantized transform coefficient to obtain a residual signal. On the other hand, according to the known coding mode information, a predicted signal corresponding to the CU may be obtained. After the residual signal is added to the predicted signal, a reconstructed signal may be obtained. Finally, an in-loop filtering operation needs to be performed to decode the reconstructed signal of the picture, to generate a final outputted signal, thereby implementing video decoding.

Currently, mainstream video coding standards such as HEVC, VVC, AVS3, AV1, and AV2 all use a block-based hybrid coding framework, and may follow the foregoing coding procedure: An original video is first partitioned into a series of CUs, and coding is performed in combination of video coding methods such as the predictive coding, the transform, and the entropy coding, to obtain a coded bitstream of the video, thereby implementing video compression. Different video coding standards support specific partition structures, specific transform modes, and the like. For example, AVS3 supports a quad tree (QT) structure, a binary tree (BT) structure, an extended quad tree (EQT) structure, and other partition structures. A largest coding unit CTU may be partitioned into CUs layer by layer according to the QT structure, the BT structure, or the EQT structure. The CU is a basic unit of coding, and the CU may be processed in transform units (TUs). For another example, compared with a previous-generation coding standard, AVS3 supports more flexible transforms, including implicit selection of transforms (IST), implicit selection of transform skip (ISTS), a position based transform (PBT), a sub-Block transform (SBT), a secondary transform (ST), an enhanced secondary transform (EST), a decoder-end enhanced secondary transform (DEST), and the like. A DCT with a maximum size of 64×64 may be used for a large CU in coding of an ultra-high-definition video.

The following separately describes the foregoing transform modes (or may be referred to as transform tools or transform methods) in the AVS3 standard.

### (1) IST

The IST technology is adopted in AVS3 Phase 2. The IST is a technology used in video coding and is configured for optimizing a transform selection process, to improve coding efficiency and picture quality. The idea of the IST is to dynamically select a most suitable transform method according to a characteristic of an inputted signal. The IST is a newly added transform tool for an intra block (for example, an intra residual block) in AVS3. For the intra residual block, in addition to a DCT-II transform, a DST-VII transform is introduced to the IST technology. The DCT-II and the DST-VII are two separable transform kernels provided by the IST for the intra residual block. When an intra prediction residual is transformed through the DST-VII, the DST-VII is used as a transform kernel for both horizontal and vertical transforms. In the IST technology, whether to use the DST-VII is identified by using parity of the number of even coefficients. An odd number indicates that the DST-VII is to be used, and an even number indicates that the DCT-II is to be used. The IST may be applied to CUs whose sizes range from 4×4 to 32×32, but is not applied to a CU obtained through partition using a derived tree (DT). In the IST technology, a coder may select an optimal transform kernel according to RDO. However, an index of the selected transform kernel is not transmitted in a coded bitstream, but is hidden in parity of a non-zero transform coefficient. A decoder side may derive the corresponding transform kernel according to the parity.

### (2) ISTS

The ISTS is a technology used in video coding, aiming to improve coding efficiency. The ISTS allows a coder to skip a transform operation in some cases, thereby reducing a computation amount and a bit rate. AVS3 Phase 2 supports a transform skip (TS) mode, and whether the transform needs to be skipped is indicated by parity of the number of non-zero coefficients of a coefficient block. When implicit TS is enabled in a sequence header, a decoder determines, according to parity of the number of non-zero coefficients of a current reference block, whether an inv. transform needs to be performed or whether the transform needs to be skipped. For an inter picture, a picture header further includes another switch to control whether an inter CU (for example, a CU using the inter prediction mode) of the picture is to use TS. The ISTS is similar to the IST, and is also for an intra block. When the ISTS is enabled, if a CU uses a TS mode, a flag bit is not directly transmitted, but is derived according to parity.

### (1) for an Intra CU:

An ETS flag bit is transmitted in a coded bitstream. If the flag bit is 0, an inverse DCT-II (for example, DCT2) transform is performed. If the flag bit is 1, whether to perform residual inversion (RTS) is determined according to parity of the number of non-zero coefficients. If the number of non-zero coefficients is odd (an index is 1), the transform is skipped, but inversion is performed in an example of a coefficient flipping mode (for example, RTS-I (RTS-II)) shown in FIG. 1b. As shown in FIG. 1b, characters (such as “a” and “b”) in a box represent positions of corresponding coefficients. After flipping, positions of coefficients at positions g and j remain unchanged. If the number of non-zero coefficients is even (an index is 0), TS is directly performed. Indications of intra skip and flipping are enumerated in Table 1a.

TABLE 1a

| | Implicitly | |
|---|---|---|
| ETS flag | derived index | Transform |
| 0 | — | DCT2 |
| 1 | 0 | TS |
| | 1 | RTS-I (RTS-II) |

### (2) for a Non-Direct/Skip Inter CU and a Non-SBT Inter CU:

If the number of non-zero coefficients is odd, an inverse transform is not directly skipped. If the number of non-zero coefficients is even, an inverse DCT-II transform is performed. The implicit TS is applicable to an intra/inter predicted block whose size ranges from 4×4 to 32×32 or an intra block copy (IBC) coded block.

### (3) for an Inter SBT CU:

An inv. transform is directly skipped.

### (4) for an Inter Direct/Skip and Non-SBT CU:

An inverse DCT-II transform is directly used.

### (3) PBT

The PBT is a technology used in video coding. In the technology, transform selection is optimized by considering characteristics of different regions in a picture, thereby improving coding efficiency and picture quality. The PBT may be applied to an inter prediction residual block, to better fit an inter residual characteristic. For example, in FIG. 1c, a CU is partitioned into a total of four regions: 0, 1, 2, and 3, and horizontal and vertical transform combinations corresponding to the regions are enumerated in Table 1b.

TABLE 1b

| Sub-block part | Horizontal transform | Vertical transform |
|---|---|---|
| 0 | DCT8 | DCT8 |
| 1 | DST7 | DCT8 |
| 2 | DCT8 | DST7 |
| 3 | DST7 | DST7 |

In the foregoing table, Sub-block part represents a sub-block part, Horizontal transform represents a horizontal transform, and Vertical transform represents a vertical transform. Different transform combinations are used in different regions, to implement more efficient residual signal expression. Transform types (also referred to as transform kernels in the PBT) allowed by the PBT include a DCT8 and a DST7. A CU using the method has a maximum size of 32×32 and a minimum size of 8×8, and a length-width ratio of the CU is not greater than 2. Characteristics of prediction residuals at different positions in the CU are considered in the PBT. A TU is partitioned into four units according to a QT structure, and two transform kernels, for example, the DCT8 and the DST7, are respectively used for a row transform and a column transform, to further improve transform coding efficiency. In addition, this position based binding mode can effectively adapt to a distribution rule of inter residuals at different positions, thereby improving transform performance and achieving low complexity.

### (4) SBT

The SBT technology is adopted in AVS3 Phase 2. The SBT is a technology in video coding and picture processing, aiming to improve coding efficiency and picture quality. In the SBT technology, a large block in a picture or a video frame is partitioned into smaller sub-blocks, and independent transforms are performed on these sub-blocks, to process characteristics of different regions more flexibly. In the SBT, an inter residual is partitioned into two sub-blocks, where a residual of one sub-block is 0 by default, and a residual of the other sub-block is not 0 by default. There are eight selections for the size and position of the sub-block with the non-zero residual in AVS3 (such information is transmitted in a bitstream). For a transform of the sub-block with the non-zero residual, the DCT8/DST7 transform is adaptively selected as a horizontal transform and a vertical transform according to the position of the sub-block. The SBT is applied to a luma residual block of an inter-mode CU whose width and height are both less than or equal to 64.

(1) There are four types of sizes/directions of the sub-block with the non-zero residual: (i) SBT-V-1: The width of the sub-block is ½ of the width of the residual block, and the height of the sub-block is the height of the residual block. (ii) SBT-V-2: The width of the sub-block is ¼ of the width of the residual block, and the height of the sub-block is the height of the residual block. (iii) SBT-H-1: The height of the sub-block is ½ of the height of the residual block, and the width of the sub-block is the width of the residual block. (iv) SBT-H-2: The height of the sub-block is ¼ of the height of the residual block, and the width of the sub-block is the width of the residual block.

(2) There are two types of positions of the sub-block with the non-zero residual: (i) left side (for an SBT-V)/upper side (for an SBT-H) of the residual block; and (ii) right side (for an SBT-V)/lower side (for an SBT-H) of the residual block.

In combination with the types of the sizes/directions and the positions in (1) and (2), there are a total of eight combinations of sizes/directions and positions, as shown in FIG. 1d, including combinations between the SBT-V and a position 0/position 1 and between the SBT-H and the position 0/position 1, where the position 0 represents the left side/upper side of the residual block, and the position 1 represents the right side/lower side of the residual block. The combination of the size/direction is described through transmission of two flag bits in the bitstream, and the position of the sub-block with the non-zero residual is derived by using parity of the number of non-zero coefficients. In addition, whether to use the SBT mode further needs to be indicated by a flag bit. When the width or height of the sub-block with the non-zero residual is 64, both the horizontal and vertical transforms of the sub-block with the non-zero residual are a DCT-2. In other cases, selection of the horizontal and vertical transforms may be shown in FIG. 1d.

(i) No deblocking filtering is performed on a sub-block boundary inside a CU. (ii) If the sub-block mode is used, a luma CBF of the CU is 1, and luma CBFs at all 4×4 positions in the CU are stored as 1.

The secondary transform mode mentioned in the aspects of this disclosure is a technology for implementing a secondary transform, and may include at least one of the following: the ST, the EST, and the DEST. The ST, the EST, and the DEST are respectively described below.

(5) ST

AVS3 Phase 1 inherits an ST in AVS2. The ST is applied to an intra predicted block, and the ST is performed only on an upper-left 4×4 block of a transform coefficient obtained through a primary transform. There is no bitstream indication for the ST in AVS3 Phase 1, and the ST is performed on all intra predicted blocks. A transform in AVS3 Phase 2 is extended (which can be referred to as the EST). There is a flag bit in a bitstream to indicate whether to perform the transform, and the ST is extended to chroma. During use of the ST, for a block coded in the intra prediction mode, considering a special statistical characteristic of a residual of the block, the ST may be performed on coefficients of an upper-left 4×4 block, to further reduce coding redundancy, so that the transform coefficients are further concentrated.

(6) EST

In some cases, the ST may not be suitable for an intra CU. Therefore, based on the ST, the EST adds a flag st_flag to each TU level, to control use of the ST, where “0” indicates not to use the ST, and “1” indicates to use the ST. In addition, the ST may be applied to a non-DT intra-coded CU, having a size ranging from 4×4 to 64×64. In addition, a new 8×8 ST kernel is introduced for a CU whose size is greater than 4×4.

Descriptions of the processing principle of the EST include the following four operations: 1. Obtain a transform coefficient matrix. 2. Perform an inverse vertical transform on the transform coefficient matrix, to obtain a matrix K. 3. Perform an inverse horizontal transform on the matrix K, to obtain a matrix H. 4. Directly use the matrix H as a residual sample matrix (ResidueMatrix).

For an implementation of each operation, refer to content in the following procedures 1 to 4.

1. If a current transform block is an intra prediction residual block, a value of M1 or M2 is greater than 4, and a value of StEnableFlag (an ST enable flag) is equal to 1, perform the following operations on CoefMatrix (the transform coefficient matrix). M1 and M2 are size parameters of the intra prediction residual block, M1 represents the height of the intra prediction residual block, and M2 represents the width of the intra prediction residual block. Operations on the transform coefficient matrix mainly include content in (a) to (d).

(a) Obtain a 4×4 matrix C by using the transform coefficient matrix CoefMatrix. Code logic is as follows:

for (i=0; i<4; i++) {
for (j=0; j<4; j++) {
C[i][j] = CoeffMatrix[i][j]
}
}

(b) If the current transform block satisfies one of the following four conditions: (i) the current transform block is a luma prediction residual block, EnhancedStEnableFlag (an EST enable flag) is equal to 0, IntraLumaPredMode (an intra luma prediction mode) is equal to 0 to 2, 13 to 32, or 44 to 65, and a reference sample whose coordinate is (x0−1, y0+j−1) (j=1 to M2) is “available”; (ii) the current transform block is a luma prediction residual block, DtSplitFlag (a DT split flag) is equal to 1, IntraLumaPredMode (an intra luma prediction mode) is equal to 0 to 2, 13 to 32, or 44 to 65, and a reference sample whose coordinate is (x0−1, y0+j−1) (j=1 to M2) is “available”; (iii) the current transform block is a luma prediction residual block, and both EnhancedStEnableFlag (an EST enable flag) and EstTuFlag (a TU-level EST flag) are equal to 1; or (iv) the current transform block is a chroma prediction residual block, and both EnhancedStEnableFlag (an EST enable flag) and ChromaStFlag (a chroma-level ST flag) are equal to 1, first obtain a matrix P, and then obtain C. Refer to the following code logic, where S₄ is a 4×4 inverse transform matrix:

P = C × S₄
for (i=0; i<4; i++) {
for (j=0; j<4; j++) {
C[i][j] = Clip3(−32768, 32767, (P[i][j] + 2⁶) >> 7)
}

(c) If the current transform block satisfies one of the following four conditions: (i) the current transform block is a luma prediction residual block, EnhancedStEnableFlag (the EST enable flag) is equal to 0, IntraLumaPredMode (the intra luma prediction mode) is equal to 0 to 23 or 34 to 57, and a reference sample whose coordinate is (x0+i−1, y0−1) (i=1 to M1) is “available”; (ii) the current transform block is a luma prediction residual block, DtSplitFlag (the DT split flag) is equal to 1, IntraLumaPredMode (the intra luma prediction mode) is equal to 0 to 23 or 34 to 57, and a reference sample whose coordinate is (x0+i−1, y0−1) (i=1 to M1) is “available”; (iii) the current transform block is a luma prediction residual block, and both EnhancedStEnableFlag (the EST enable flag) and EstTuFlag (the TU-level EST flag) are equal to 1; or (iv) the current transform block is a chroma prediction residual block, and both EnhancedStEnableFlag (the EST enable flag) and ChromaStFlag (the chroma-level ST flag) are equal to 1, first obtain a matrix Q, and then obtain C. Refer to the following code logic, where S₄^{T} is a transpose of S₄, and the transpose is an operation of interchanging rows and columns of a matrix:

Q = S₄^{T} × C
for (i=0; i<4; i++) {
for (j=0; j<4; j++) {
C[i][j] = Clip3(−32768, 32767, (Q[i][j] + 2⁶) >> 7)
}
}

(d) Modify the transform coefficient matrix according to the matrix C. Code logic is as follows:

for (i=0; i<4; i++) {
for (j=0; j<4; j++) {
CoeffMatrixf[i][j] = C[i][j]
}
}

2. Perform the inverse vertical transform on the transform coefficient matrix, to obtain the matrix K.

(a) Obtain a matrix V by using the transform coefficient matrix and an inverse transform matrix.

(b) If M₁ and M₂ are both equal to 4, StEnableFlag is equal to 1, and one of the following conditions (i) to (iv) is satisfied: (i) if the current transform block is a luma intra prediction residual block, and EnhancedStEnableFlag (the EST enable flag) is equal to 0; (ii) if the current transform block is a luma intra prediction residual block, and DtSplitFlag (the DT split flag) is equal to 1; (iii) if the current transform block is a luma intra prediction residual block, and both EnhancedStEnableFlag (the EST Enable Flag) and EstTuFlag (the TU-level EST Flag) are equal to 1; or (iv) if the current transform block is a chroma intra prediction residual block, and both EnhancedStEnableFlag (the EST enable flag) and ChromaStFlag (the chroma-level ST flag) are equal to 1, computation logic of the matrix V is as follows, where D₄^{T} is a transpose of a 4×4 inverse transform matrix D₄:

V = D₄^{T} × CoeffMatrix
(c) Obtain the matrix K by using the matrix V.
Code logic is as follows:
for (i=0; i<M₁; i++) {
for (j=0; j<M₂; j++) {
K[i][j] = Clip3(−32768, 32767, (V[i][j] + 2⁴) >> 5)
}
}

3. Perform the inverse horizontal transform on the matrix K, to obtain the matrix H.

(a) Obtain a matrix W by using the transform coefficient matrix and the inverse transform matrix, and obtain a maximum value (Max Value) and shift data shift1. For example, if the values of M₁ and M₂ are both equal to 4, StEnableFlag (the ST enable flag) is equal to 1, and one of the following conditions (i) to (iv) is satisfied: (i) if the current transform block is a luma intra prediction residual block, and EnhancedStEnableFlag is equal to 0; (ii) if the current transform block is a luma intra prediction residual block, and DtSplitFlag (the DT split flag) is equal to 1; (iii) if the current transform block is a luma intra prediction residual block, and both EnhancedStEnableFlag (the EST Enable Flag) and EstTuFlag (the TU-level EST Flag) are equal to 1; or (iv) if the current transform block is a chroma intra prediction residual block, and both EnhancedStEnableFlag (the EST enable flag) and ChromaStFlag (the chroma-level ST flag) are equal to 1, computation logic of the maximum value Max Value, the shift data shift1, and the matrix W is as follows, where D₄ is a 4×4 inverse transform matrix:

W = K × D₄
Max Value = (1 << BitDepth) − 1
shift1 = 22 − BitDepth
(b) Obtain the matrix H by using the matrix W.
Code logic is as follows:
for (i=0; i<M₁; i++) {
for (j=0; j<M₂; j++) {
H[i][j] = Clip3(−Max Value−1, Max Value,
(W[i][j] + 2^{shift1-1}) >> shift1)

4. Directly use the matrix H as the residual sample matrix (ResidueMatrix).

The inverse transform matrices S₄ and D₄ for the secondary transform in the foregoing procedure are as follows:

S₄ = {
123, −35, −8, −3 }
{−32, −120, 30, 10}
14, 25, 123, −22}
{8, 13, 19, 126} }
D₄ = {
{34, 58, 72, 81}
{77, 69, −7, −75}
(79, −33 −75, 58}
{55, −84, 73, −28} }
(7) DEST

An AVS3 next-generation reference software platform (Enhanced Video Model, EVM, which is fully referred to as a reference software platform for a next-generation international video coding standard) adopts the DEST technology. A secondary transform kernel of a larger size is introduced to an optimization and improvement solution for a secondary transform technology of a luma component in the EVM, a secondary transform candidate is added, and an expression method for a secondary transform type is adaptively updated. In the luma secondary transform technology of AVS3, a flag bit is coded to explicitly identify whether a current block is to use a secondary transform. In this method, a transform type cannot be further extended, and the coding of the flag bit causes additional overheads to some extent. Based on this, a new transform is introduced to the DEST technology, a transform type added, and the expression method is updated. During an example of an implementation, an 8×8 secondary transform kernel is introduced to the DEST for a size greater than 8, as shown in FIG. 1e. The new secondary transform type introduced to the DEST is mainly obtained by flipping a current residual block. Three different flipping modes include: horizontal flipping, vertical flipping, and 180° diagonal flipping.

In an implementation, the DEST uses a decoder-side prediction mode. For example, on a decoder side, a boundary pixel value P of a current block may be predicted by using a pixel within a neighboring range of the current block. Inverse transforms are performed on a transform coefficient by using different secondary transform types to obtain four candidate results Qi (i=1, 2, 3, or 4) of the boundary pixel value. Then, absolute values Ri of differences between the four boundary pixel value candidates Qi and the predicted boundary pixel value P are calculated. Finally, the four absolute values Ri are sorted, and a type with the smallest absolute value Ri is selected as a secondary transform type for true decoding.

Based on the fact that the secondary transform type with the smallest absolute value Ri is selected by default as the secondary transform type of the DEST in the foregoing mode, in another feasible implementation, a coder side may alternatively execute the content predicted by the decoder side. After Ri sorting, the coder side may transmit an index that is in a list and that indicates a selected secondary transform type. The decoder side obtains the index through decoding, performs a same resorting operation to derive the list, and determines the selected secondary transform type. In this way, the decoder side can determine the secondary transform type according to the index only, thereby improving decoding performance.

Based on the foregoing related descriptions, the aspects of this disclosure provide a data processing solution. The solution includes a processing procedure on a coder side and a processing procedure on a decoder side.

(1) The processing procedure on the coder side is for example as follows:

(i) Determine transform mode syntax control information that needs to be used for a video, the transform mode syntax control information being configured for controlling use of a transform mode. (ii) Code the video. (iii) Code the transform mode syntax control information into a coded bitstream of the video in a coding process.

(2) The processing procedure on the decoder side is for example as follows:

(i) Obtain a coded bitstream of a video, the coded bitstream including transform mode syntax control information, and the transform mode syntax control information being configured for controlling use of a transform mode. (ii) Decode the coded bitstream. (iii) Control the use of the transform mode according to the transform mode syntax control information in a decoding process.

It can be learned from the foregoing solution that in this disclosure, the use of the transform mode in the decoding process can be flexibly controlled by using the transform mode syntax control information by adding the transform mode syntax control information to the coded bitstream, thereby effectively guiding a transform procedure in the decoding process. The coded bitstream is decoded, and the use of the transform mode is controlled according to the transform mode syntax control information in the decoding process. In this mode, the use of the transform mode can be flexibly controlled based on the transform mode syntax control information in the coded bitstream in the decoding process, thereby improving coding/decoding efficiency. A transform mode of a corresponding type can be adaptively enabled or disabled in different scenarios by using the transform mode syntax control information, so that the use of the transform mode in a corresponding scenario is flexibly and appropriately controlled. This is beneficial to improving video coding performance and decoding performance.

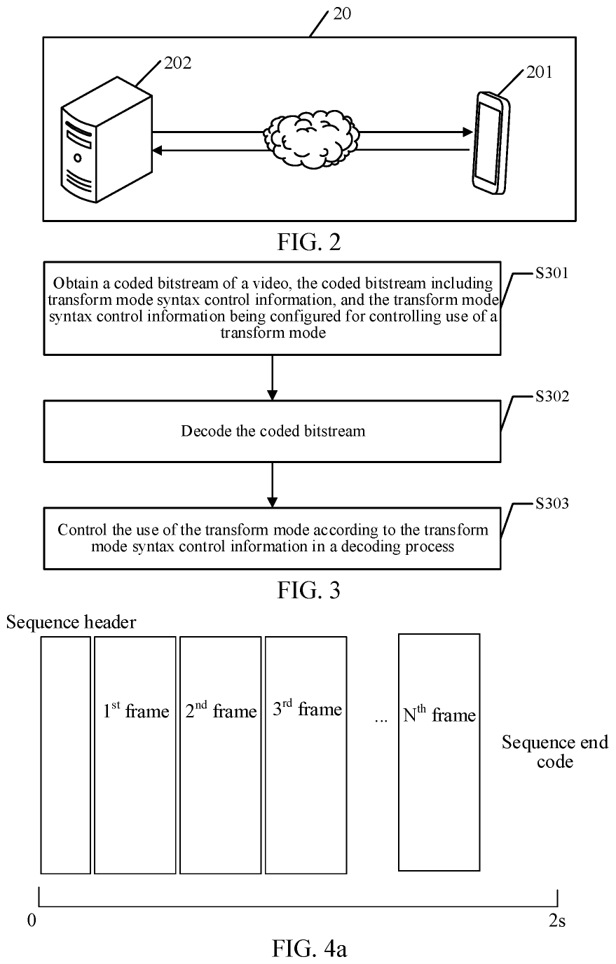

With reference to FIG. 2, the following describes a data processing system according to an aspect of this disclosure. As shown in FIG. 2, the data processing system 20 may include a service device 201 and a consumer device 202. The service device 201 may be used as a coder side of a video, and the service device 201 may be a terminal device or may be a server. The consumer device 202 may be used as a decoder side of the video, and the consumer device 202 may be a terminal device or may be a server. A communication connection may be established between the service device 201 and the consumer device 202. The terminal device may be a smartphone, a tablet computer, a notebook computer, a desktop computer, a smart speaker, a smartwatch, a vehicle-mounted terminal, a smart television, or the like, but is not limited thereto. The server may be an independent physical server, may be a server cluster or a distributed system including multiple physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

Data processing procedures performed by the service device 201 and the consumer device 202 are as follows: The service device 201 mainly performs the following data processing processes: (i) a video obtaining process; (ii) determining transform mode syntax control information needed by a video; and (iii) a video coding process. The consumer device 202 mainly performs the following data processing processes: (iv) a video decoding process; and (v) controlling use of a transform mode according to the transform mode syntax control information.

In addition, a video transmission process is performed between the service device 201 and the consumer device 202. The transmission process may be performed based on various transmission protocols (or transmission signaling). The transmission protocols herein may include but are not limited to the Dynamic Adaptive Streaming over HTTP (DASH) protocol, the HTTP 1 Live Streaming (HLS) protocol, the Smart Media Transport Protocol (SMTP), the Transmission Control Protocol (TCP), and the like.

The following describes the data processing processes in detail:

### (i) Video Obtaining Process

The service device 201 may obtain the video, where the video may be obtained in two modes: scene capture or generation by the device. Obtaining the video through the scene capture means capturing a visual scene in the real world by using a capture device associated with the service device 201, to obtain the video. The capture device is configured to provide a video obtaining service for the service device 201. The capture device may include but is not limited to any one of the following: a camera device, a sensing device, and a scanning device. The camera device may include an ordinary camera, a stereoscopic camera, a light field camera, and the like. The sensing device may include a laser device, a radar device, and the like. The scanning device may include a three-dimensional laser scanning device and the like. The capture device associated with the service device 201 may be a hardware component disposed in the service device 201. For example, the capture device is a camera, a sensor, or the like of the terminal. The capture device associated with the service device 201 may alternatively be a hardware apparatus connected to the service device 201, for example, a camera connected to the service device 201. Generating the video by the device means that the service device 201 generates the video based on a virtual object, for example, records screen content to generate a recording picture; or generates a stereoscopic video according to a virtual three-dimensional object and a virtual three-dimensional scene obtained through three-dimensional modeling, to provide more immersive visual experience.

### (ii) Determining the Transform Mode Syntax Control Information Needed by the Video

In an implementation, the service device 201 may determine, for the video according to a coding scenario to which the video belongs, a syntax element needed by a syntax structure of at least one level. Each syntax element is configured for controlling use of a secondary transform mode by an object (for example, a video sequence) of a corresponding syntax structure. Therefore, the transform mode syntax control information is formed according to at least one syntax element, and the transform mode syntax control information is configured for controlling use of the secondary transform mode.

(iii) Video Coding Process

The service device 201 may code the video, to obtain a coded bitstream of the video. For the video coding process, refer to the coding procedure shown in FIG. 1a. The video is partitioned into multiple CUs, and coding is performed in combination of video coding methods such as prediction, a transform, and entropy coding. In the process of coding the video, the service device 201 may determine, based on the transform mode syntax control information, a transform mode that needs to be used, and then perform the transform in the transform mode. For example, prediction is performed on a specific CU in an intra prediction mode at a prediction stage, and a secondary transform is performed on the CU in a DEST mode at a transform stage. Prediction is performed on a specific CU in an inter prediction mode at a prediction stage, and a transform is performed in a PBT mode at a transform stage.

In an implementation, after obtaining the transform mode syntax control information, the service device 201 may code the transform mode syntax control information into the coded bitstream of the video. If the transform mode syntax control information is configured for controlling the use of the secondary transform mode, a syntax element may be added to a syntax structure of each level in the coding process, to code the transform mode syntax control information into the coded bitstream. For example, the obtained video is an ultra-high definition video, and a corresponding coding scenario is an ultra-high definition video coding scenario. To improve coding efficiency in the ultra-high definition video coding scenario, syntax elements may be added to a sequence header, a picture header, and a slice header, to control enabling or disabling of the DEST mode. These syntax elements are content in the transform mode syntax control information. The coded bitstream including the transform mode syntax control information may be obtained through the coding, so that the use of the transform mode is controlled in the decoding process based on the transform mode syntax control information. In this disclosure, a coded bitstream of a video is a binary data stream obtained by coding the video. Original data may be converted into a series of binary data through the coding, and related information (such as the foregoing transform mode syntax control information) in the coding process is included, so that the video can be effectively restored in a transmission or storage process.

### (iv) Video Decoding Process

The consumer device 202 may obtain the coded bitstream of the video, decode the coded bitstream, obtain transform mode syntax control information in the coded bitstream through the decoding, and control the use of the transform mode according to the transform mode syntax control information in the decoding process. For example, the transform mode syntax control information is configured for controlling use of multiple types of secondary transform modes (such as the DEST mode). In this case, whether the DEST mode is allowed to be used may be determined according to the transform mode syntax control information.

### (v) Controlling the Use of the Transform Mode According to the Transform Mode Syntax Control Information

In this disclosure, transform modes may include, but are not limited to, the secondary transform mode (for example, an ST mode, an EST mode, or the DEST mode) and other transform modes (for example, a PBT mode, an SBT mode, or an IST mode). Based on a type of the transform mode, the controlling the use of the transform mode according to the transform mode syntax control information may include: allowing use of some types of transform modes and/or prohibiting use of some types of transform modes. Control of use of a specific type of transform mode may include: indicating that the type of transform mode is allowed to be used or indicating that the type of transform mode is prohibited from being used. For example, if the transform mode includes the secondary transform mode, the transform mode syntax control information may be configured for controlling the use of the secondary transform mode, and for example indicates that the DEST mode is allowed to be used.

In the technical solution provided in this disclosure, the transform mode syntax control information may be high-level syntax control information related to the transform mode, and can be used as a high-level syntax control switch, to enable or disable the transform mode in a high-level syntax structure, thereby flexibly controlling the use of the transform mode. In addition, the transform mode syntax control information may be provided for different video coding/decoding scenarios. Whether a corresponding transform mode is to be used is determined according to such high-layer syntax control information, and a transform mode of a corresponding type is allowed to be adaptively enabled or disabled according to different scenarios, instead of remaining enabled by default, so that a transform mode is adapted to a requirement of a coding/decoding scenario. This not only can improve flexibility of controlling the use of the transform mode, but also helps improve coding performance and decoding performance.

The technical solution provided in the aspects of this disclosure may be applied to any video coding/decoding scenario, including but not limited to, a screen content coding/decoding scenario, a non-screen content coding/decoding scenario, an ultra-high definition video coding/decoding scenario, a high definition video coding/decoding scenario, and the like. The transform mode includes the secondary transform mode, and therefore, the technical solution may also be applied to a video codec or a video compression product using a secondary transform (such as DEST) technology. This is not limited in this disclosure. For example, the DEST technology is adopted in an EVM platform, and the DEST mode is enabled by default (in other words, the DEST mode is allowed to be used). It is learned by testing test video sequences in different scenarios that, in the screen content coding/decoding scenario, if the DEST mode remains enabled all the time, coding performance of a test video sequence in the screen content coding/decoding scenario cannot be improved, and coding time may be further increased. In this solution, use of the DEST mode may be controlled by using the transform mode syntax control information in the screen content coding/decoding scenario. For example, the DEST mode is disabled (in other words, the DEST mode is prohibited from being used) in high-layer syntax. In this way, coding time and decoding time can be reduced to some extent through flexible control of the DEST mode, thereby improving coding performance and decoding performance.

FIG. 3 is a schematic flowchart of a data processing method according to an aspect of this disclosure. The data processing method may be performed by the consumer device 202 in the data processing system. The method includes the following operations S301 to S303.

S301: Obtain a coded bitstream of a video, the coded bitstream including transform mode syntax control information, and the transform mode syntax control information being configured for controlling use of a transform mode. For example, the coded bitstream includes transform mode syntax control information of a secondary transform mode. The secondary transform mode is determined from a plurality of secondary transform modes based on the transform mode syntax control information.

In an example of an implementation, the transform mode includes at least one of the following: a PBT mode, an SBT mode, and a secondary transform mode. The secondary transform mode includes multiple types, including but not limited to: an ST mode, an EST mode, and a DEST mode. The transform mode syntax control information may be configured for controlling use of one or more of the foregoing types of transform modes. For example, the transform mode includes the secondary transform mode, and the transform mode syntax control information may be configured for controlling use of the secondary transform mode. The control of the use of the secondary transform mode is based on the multiple types of the secondary transform mode. For a specific type of secondary transform mode, controlling use of the type of secondary transform mode may include: allowing the type of secondary transform mode to be used or prohibiting the type of secondary transform mode from being used. In a broader aspect, the transform mode syntax control information may indicate a type of secondary transform mode that is allowed to be used and/or a type of secondary transform mode that is prohibited from being used. For example, the ST mode is allowed to be used, but the EST mode and the DEST mode are prohibited from being used.

In an implementation, the transform mode syntax control information is set in a syntax structure of the coded bitstream; and the syntax structure includes at least one of the following: a video sequence, a picture, a slice, a CU, and a TU.

The syntax structure of the coded bitstream of the video is a unit structure for processing the video. In an implementation, when there are multiple types of syntax structures of the coded bitstream, there is a hierarchy between the multiple types of syntax structures. In some aspects, the syntax structures of the coded bitstream may include the following several types: the video sequence, the picture, the slice, a largest CU, the CU, and the TU. The hierarchy is: the video sequence>the picture>the slice>the largest CU>the CU>the TU. The video sequence is a highest-level syntax structure in the coded bitstream. Based on the hierarchy, when the coded bitstream is decoded, the decoding starts from the highest level. Because a coding process includes a process of determining a parameter for each level and a process of writing the parameters into the coded bitstream, the parameters may be written into the bitstream when the video is coded. An order of writing the parameters into the bitstream is similar to a decoding order, for example, higher-level information is first written, and then lower-level information is written, so that the higher-level information can be obtained when the decoding starts.

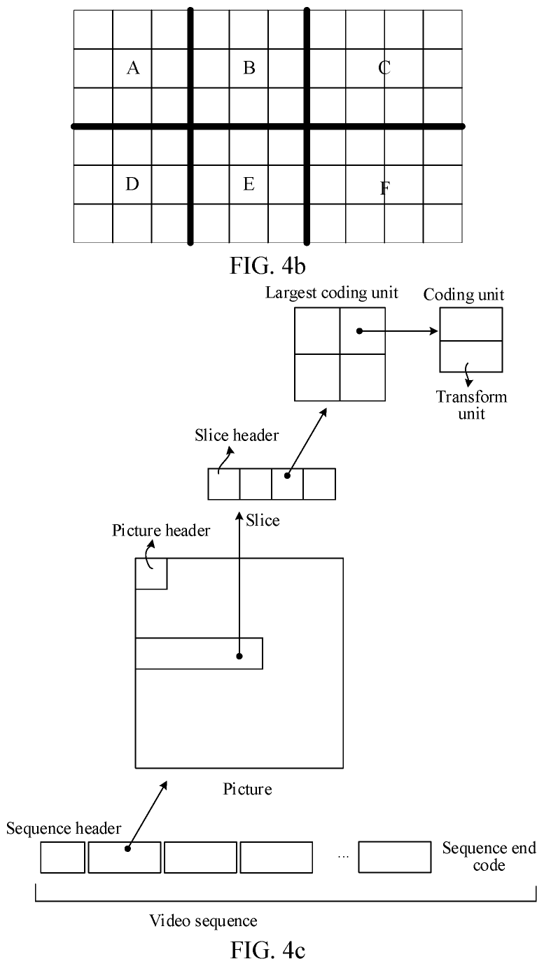

The video sequence is a dataset including a series of consecutive video frames (for example, pictures). The video sequence starts from the 1^{st} sequence header and ends at a sequence end code or a video editing code. The sequence header is configured for storing some key parameters and information. The parameters and information may be configured for describing an attribute of the video sequence. Therefore, the sequence header is an important part in a video coding standard. For example, the sequence header includes a picture size, a frame rate, a color space, and a coding parameter. Before the video sequence is decoded, the sequence header may be read and parsed to obtain configuration information of the video sequence, and the decoding is performed according to the configuration information, to restore the original video frames. The sequence end code or the video editing code indicates an end of the video sequence, and a sequence header between the 1^{st} sequence header and a sequence end code or video editing code that appears first in the video sequence is a repeated sequence header. Each sequence header is followed by one or more pictures, and each picture is preceded by a picture header. The pictures are arranged in a bitstream order in the coded bitstream, and the bitstream order is the same as the decoding order, but the decoding order may be different from a display order. For a schematic diagram of a structure of the video sequence, refer to a 2-second(s) video sequence shown in FIG. 4a. The video sequence includes a sequence header, and includes N frames of pictures after the sequence header; and a sequence end code appears after the N frames of pictures to indicate that the video sequence ends.

The picture is a coded picture. One picture may be one frame or one field, and coded data of the picture starts from a picture start code and ends at a sequence start code, the sequence end code, or a next picture start code. In the coded bitstream, coded data of two fields of an interlaced picture may appear sequentially, or may be interleaved. Decoding and display orders of the two fields of data are specified in a picture header. For the interlaced picture, an even-numbered row is referred to as a top-field row, an odd-numbered row is referred to as a bottom-field row, all top-field rows are referred to as a top field, and all bottom-field rows are referred to as a bottom field. Therefore, the foregoing two fields include the bottom field and the top field. Types of pictures may include: an intra frame (I frame for short), a predicted frame (P frame for short), and a bi-directional predicted frame (B frame for short). The I frame is a key frame. Each I frame is a complete picture frame, is decoded not depending on another frame, and can be displayed independently. The P frame is a predicted frame, and is generated by performing motion estimation and difference coding on a forward reference frame. The P frame stores only difference information from a previous frame, and a complete picture can be restored through decoding with reference to the previous frame. Compared with the I frame, the P frame has a higher compression ratio because the P frame stores only a changed part. The B frame is a bi-directional predicted frame, and is generated by performing motion estimation and difference coding on both a previous frame and a next frame. The B frame stores difference information from the previous reference frame and the next reference frame, and a complete picture can be restored through decoding with reference to the two reference frames. Compared with the P frame, the B frame has a higher compression ratio because the B frame stores more difference information.

The slice (or a tile) is a rectangular region in a picture, and may include multiple largest CU parts in the picture. Slices do not overlap each other. This is because the picture may be partitioned into largest CUs, the largest CUs do not overlap each other, an upper-left sample of the largest CU cannot exceed a picture boundary, and a lower-right sample of the largest CU can exceed a picture boundary. For example, refer to a schematic diagram of a structure of a slice shown in FIG. 4b. Regions identified by characters (including A, B, C, D, E, and F) represent slice structures. Each slice in a picture has a slice header. Each slice header is a part for describing and configuring parameters and information of each slice. The slice header includes some important parameters such as a motion vector and a quantization parameter, and such information is used by a decoder to correctly decode each slice.

The largest CU is obtained by partitioning the picture, and the largest CUs do not overlap each other. The largest CU may be further partitioned into one or more CUs. This is determined by using a coding tree (for example, a BT or a QT). The CU may be further partitioned into multiple TUs. Based on the foregoing descriptions, for a schematic diagram of a relationship among the syntax structures such as the video sequence, the picture, the slice, and the largest CU, refer to FIG. 4c.

In this disclosure, the transform mode syntax control information may be set in one or more syntax structures in the video sequence, the picture, the slice, the CU, and the TU. Because of existence of the CU, the TU, and the like, the video sequence, the picture, and the slice are higher-level syntax structures. Therefore, transform mode syntax control information that is set in the video sequence, the picture, and the slice is high-level syntax control information.

In an example of an implementation, if the transform mode includes the secondary transform mode, the transform mode syntax control information may be configured for controlling the use of the secondary transform mode. The transform mode syntax control information includes at least one syntax element, and each syntax element is configured for controlling use of the secondary transform mode by a current object. The current object is a syntax structure that is being decoded in the coded bitstream. In other words, use of the secondary transform mode by various syntax structures may be controlled by syntax elements in the transform mode syntax control information. For example, the transform mode syntax control information includes two syntax elements. One syntax element is configured for controlling use of the secondary transform mode by a video sequence that is being decoded in the coded bitstream, and the other syntax element is configured for controlling use of the secondary transform mode by a picture that is being decoded in the coded bitstream. The controlling use of the secondary transform mode by a current object includes: indicating that the current object is allowed to use some types of secondary transform modes, and/or the current object is prohibited from using some types of secondary transform modes.

Because each syntax element is configured for controlling the use of the secondary transform mode by the current object (for example, the syntax structure that is being decoded in the coded bitstream), the syntax structure corresponding to the current object is a syntax structure on which the syntax element functions. For example, if a specific syntax element is configured for controlling use of the secondary transform mode by a current video sequence, the syntax element functions on the current video sequence, the video sequence is a syntax structure on which the syntax element functions, and the syntax element is set in a sequence header. Based on this, the syntax element included in the transform mode syntax control information may be set in a corresponding type of video header (for example, a sequence header, a picture header, or a slice header) according to the syntax structure on which the syntax element functions. Each type of video header corresponds to one syntax structure, is a part of the corresponding syntax structure, and is configured for storing and transmitting key parameters and information of the corresponding syntax structure. The following describes in detail the syntax element included in the transform mode syntax control information. Refer to (i) to (iii) below.

(i) If the syntax structure includes the video sequence, the transform mode syntax control information is set in the sequence header of the current video sequence, the transform mode syntax control information is a sequence header syntax element (seq_flag), the current object is the current video sequence, and the sequence header syntax element is configured for controlling the use of the secondary transform mode by the current video sequence.

The current video sequence is a video sequence that is being decoded in the coded bitstream. The transform mode syntax control information includes the sequence header syntax element (which may also be referred to as a sequence header flag) that is set in the sequence header of the current video sequence. The sequence header syntax element functions on the current video sequence. For example, based on the multiple types of the secondary transform mode, when controlling the use of the secondary transform mode by the current video sequence, the sequence header syntax element may indicate one or more types of secondary transform modes that are allowed to be used by the current video sequence and/or one or more types of secondary transform modes that are prohibited from being used by the current video sequence. For example, the sequence header syntax element indicates that the current video sequence is allowed to use the ST mode, the EST mode, and the DEST mode. For another example, the sequence header syntax element indicates that the current video sequence is allowed to use the ST mode, but is prohibited from using the EST mode and the DEST mode.

(ii) If the syntax structure includes the picture, the transform mode syntax control information is set in a picture header of a current picture, the transform mode syntax control information is a picture header syntax element (pic_flag), the current object is the current picture, and the picture header syntax element is configured for controlling use of the secondary transform mode by the current picture.

The current picture is a picture that is being decoded in the coded bitstream. The transform mode syntax control information includes the picture header syntax element (which may also be referred to as a picture header flag) that is set in the picture header of the current picture, and the picture header syntax element functions on the current picture. For example, based on the multiple types of the secondary transform mode, when controlling the use of the secondary transform mode by the current picture, the picture header syntax element may indicate one or more types of secondary transform modes that are allowed to be used by the current picture and/or one or more types of secondary transform modes that are prohibited from being used by the current picture. For example, the picture header syntax element indicates that the current picture is allowed to use the ST mode, the EST mode, and the DEST mode. For another example, the picture header syntax element indicates that the current picture is allowed to use the ST mode, but is prohibited from using the EST mode and the DEST mode.

(iii) If the syntax structure includes the slice, when the transform mode syntax control information is set in a slice header of a current slice, the transform mode syntax control information is a slice header syntax element (slice_flag), the current object is the current slice, and the slice header syntax element is configured for controlling use of the secondary transform mode by the current slice.

The current slice is a slice that is being decoded in the coded bitstream. The transform mode syntax control information includes the slice header syntax element (which may also be referred to as a slice flag or a slice header flag) that is set in the slice header of the current slice, and the slice header syntax element functions on the current slice. For example, based on the multiple types of the secondary transform mode, when controlling the use of the secondary transform mode by the current slice, the slice header syntax element may indicate one or more types of secondary transform modes that are allowed to be used by the current slice and/or one or more types of secondary transform modes that are prohibited from being used by the current slice. For example, the slice header syntax element indicates that the current slice is allowed to use the ST mode, the EST mode, and the DEST mode. For another example, the slice header syntax element indicates that the current slice is allowed to use the ST mode, but is prohibited from using the EST mode and the DEST mode.

Because the syntax structures in the coded bitstream may include a plurality of types in the video sequence, the picture, and the slice, the foregoing syntax elements may also be combined into a plurality of types. For example, the transform mode syntax control information may include a plurality of types in the sequence header syntax element, the picture header syntax element, and the slice header syntax element. For example, the transform mode syntax control information includes the sequence header syntax element and the picture header syntax element. For another example, the transform mode syntax control information includes the sequence header syntax element and the slice header syntax element. For still another example, the transform mode syntax control information includes the sequence header syntax element, the picture header syntax element, and the slice header syntax element.

For ease of understanding decoding of various syntax elements in this disclosure, the following first describes a bitstream description method and a descriptor briefly.

In this disclosure, the transform mode syntax control information may be used as content in a bitstream syntax description, and a bitstream syntax description method is similar to the C language. A syntax element in a bitstream may be represented in bold, and each syntax element is described by using a name (English letter groups separated by an underline, where all letters are lower-case), syntax, and semantics. Values of syntax elements in a syntax table and a main text are represented by a normal font.

In some cases, another variable value derived from a syntax element may be applied in the syntax table, and such a variable is named by using a mixture of a lower-case letter and an upper-case letter with no underline in the syntax table or the main text. A variable starting with an upper-case letter is configured for decoding a current syntax structure and a related syntax structure, and may also be configured for decoding a subsequent syntax structure. Variables starting with lower-case letters are used only in subclauses in which the variables are located.

A relationship between mnemonic symbols of a syntax element value and a variable value and values of the mnemonic symbols is described in the main text. In some cases, the mnemonic symbol and the value are used equivalently. The mnemonic symbol is represented by one or more letter groups separated by an underline. Each letter group starts with an upper-case letter or may include multiple upper-case letters.

When the length of a bit string is an integer multiple of 4, the bit string may be represented by a hexadecimal symbol. A prefix of the hexadecimal symbol is “0x”. For example, “0x1a” represents a bit string “00011010”. In a conditioning statement, 0 represents FALSE, and a non-0 value represents TRUE. The syntax table describes a superset of all bitstream syntax conforming to this file, and an additional syntax limitation is described in a related item. When a syntax element appears, one data unit is read from the bitstream.

Table 2a provides a pseudocode example of a syntax description. When a syntax element appears, one data unit is read from the bitstream.

TABLE 2a

| Pseudocode | Descriptor |
|---|---|
| /* A statement is a descriptor of a syntax element, or indicates existence, a | |
| type, and a value of the syntax element. Two examples are provided below. */ | |
| syntax_element | ue(v) |
| conditioning statement | |
| /* A statement group enclosed by curly braces is a compound statement, | |
| and is considered as a single statement in function. */ | |
| { | |
| statement | |
| ... | |
| } | |
| /* A ″while″ statement is configured for testing whether a condition is | |
| TRUE; and if the condition is TRUE, a loop body is repeatedly executed until | |
| the condition is not TRUE. */ | |
| while (condition) | |
| statement | |
| /* For a ″do ... while″ statement, a loop body is first executed once, and | |
| then it is tested whether a condition is TRUE; and if the condition is TRUE, | |
| the loop body is repeatedly executed until the condition is not TRUE. */ | |
| do | |
| statement | |
| while (condition) | |
| /* For an ″if ... else″ statement, a condition is first tested. If the condition | |
| is TRUE, a primary statement is executed. Otherwise, an alternative statement | |
| is executed. If the alternative statement does not need to be executed, an ″else″ | |
| part and the related alternative statement in a structure may be ignored. */ | |
| if (condition) | |
| primary statement | |
| else | |
| alternative statement | |
| /* For a ″for″ statement, an initial statement is first executed, and then a | |
| condition is tested. If the condition is TRUE, a primary statement and a | |
| subsequent statement are repeatedly executed until the condition is not TRUE. | |
| */ | |
| for (initial statement; condition; subsequent statement) | |
| primary statement | |
| /* A ″break″ statement is used in ″do-while″, ″while″, and ″for″ loop | |
| bodies, to terminate a loop of a current loop body immediately. */ | |
| break | |

A parsing process and a decoding process are described by using words and pseudocode similar to the C language.

Next n bits of the bitstream are returned, where a most significant bit (MSB) comes first, and a bitstream pointer is advanced by n bits. If n is equal to 0, 0 is returned, and the bitstream pointer is not advanced. A function is also configured for describing the parsing process and the decoding process.

Descriptors represent parsing processes of different syntax elements. Refer to descriptors enumerated in Table 2b.

TABLE 2b

| Descriptor | Description |
|---|---|
| ae(v) | Is a syntax element in advanced entropy coding. |
| b(8) | Is a byte having any value, where a parsing process is stipulated by a return value |
| | of a function read_bits(8). |
| f(n) | Is n consecutive bits having particular values, where a parsing process is |
| | stipulated by a return value of a function read_bits(n). |
| i(n) | Is an n-bit integer, where in a syntax table, if n is ″v″, the number of bits of the |
| | integer is determined by using a value of another syntax element; and a parsing |
| | process is stipulated by a return value of the function read_bits(n), and the return |
| | value is represented by a complement of 2 with an MSB first. |
| r(n) | Is n consecutive 0s, where a parsing process is stipulated by a return value of the |
| | function read bits(n). |
| se(v) | Is a signed-integer syntax element, coded using Exponential-Golomb code. |
| u(n) | Is an n-bit unsigned integer, where in a syntax table, if n is ″v″, the number of |
| | bits of the integer is determined by using a value of another syntax element; and |
| | a parsing process is stipulated by a return value of the function read_bits(n), and |
| | the return value is represented in binary with an MSB first. |
| ue(v) | Is an unsigned-integer syntax element, coded using Exponential-Golomb code. |

For decoding of various syntax elements in this disclosure, refer to the foregoing content.

In an aspect, one syntax element may include one or more mode flags, and each mode flag may be configured for controlling use of one or more types of secondary transform modes. The secondary transform mode includes the following several types: the ST mode, the EST mode, and the DEST mode. For ease of understanding, any syntax element in the transform mode syntax control information is represented as a target syntax element. Each syntax element has similar logic. The target syntax element is used as an example below to describe specific values of mode flags in the target syntax element and functions of the target syntax element, including content in (1) to (3) below.

(1) The target syntax element includes a first mode flag (st_flag). The first mode flag may indicate use of the ST mode, the EST mode, and the DEST mode by the current object. Based on the foregoing content, if the target syntax element is the sequence header syntax element, the current object is the current video sequence; if the target syntax element is the picture header syntax element, the current object is the current picture; or if the target syntax element is the slice header syntax element, the current object is the current slice. The target syntax element mentioned below is understood in the same way.

When the target syntax element includes only one mode flag, the target syntax element may control the use of the secondary transform mode in the following mode 1 and mode 2.

Mode 1: (i) If a value of the first mode flag is a first value, the target syntax element indicates that the current object is prohibited from using the ST mode, the EST mode, and the DEST mode. (ii) If a value of the first mode flag is a second value, the target syntax element indicates that the current object is allowed to use the ST mode but is prohibited from using the EST mode and the DEST mode. (iii) If a value of the first mode flag is a third value, the target syntax element indicates that the current object is allowed to use the ST mode and the EST mode but is prohibited from using the DEST mode. (iv) If a value of the first mode flag is a fourth value, the target syntax element indicates that the current object is allowed to use the ST mode, the EST mode, and the DEST mode.

In this disclosure, the first value is, for example, “0”; the second value is, for example, “1”; the third value is, for example, “2”; and the fourth value is, for example, “3”. Being prohibited from using means being not allowed to use. It can be learned from the foregoing mode that when the target syntax element includes only one mode flag (for example, the first mode flag), different values of the first mode flag make the target syntax element have different functions or correspond to different semantics. For example, that the target syntax element controls the use of the secondary transform mode means: The first mode flag controls the use of the ST mode, the EST mode, and the DEST mode by the current object.

In an implementation, the target syntax element is the sequence header syntax element (for example, the sequence header flag, which can be referred to as seq_flag), a first mode flag included in the sequence header syntax element is denoted as seq_st_flag (a sequence-header ST flag), and the sequence header syntax element is configured for controlling use of the ST mode, the EST mode, and the DEST mode by the current video sequence. For a value of the first mode flag in the sequence header syntax element and semantic content corresponding to different values, refer to Table 3a.

TABLE 3a

| seq_st_flag | Semantics |
|---|---|
| 0 | The ST mode, the EST mode, and the DEST mode are |
| | not allowed to be used. |
| 1 | The ST mode is allowed to be used, and the EST mode |
| | and the DEST mode are not allowed to be used. |
| 2 | The ST mode and the EST mode are allowed |
| | to be used, but the DEST mode is not allowed to be used. |
| 3 | The ST mode, the EST mode, and the DEST mode |
| | are allowed to be used. |

For logic of decoding the foregoing sequence header flag, refer to content in Table 3a-1:

TABLE 3a-1

| | |
|---|---|
| seq_st_flag | u(n) |

n = ceil(log2(number of modes)). For example, n = ceil(log2(4)) = 2.

The sequence-header ST flag (seq_st_flag) represents the ST mode. A value ‘0’ indicates that the ST mode is prohibited from being used. A value greater than ‘0’ indicates that the ST mode is allowed to be used. A value of SeqStFlag is equal to the value of seq_st_flag. If seq_st_flag does not exist in the bitstream, the value of SeqStFlag is 0.

In another implementation, the target syntax element is the picture header syntax element (for example, the picture header flag, which can be referred to as pic_flag), a first mode flag included in the picture header syntax element is denoted as pic_st_flag (a picture-header ST flag), and the picture header syntax element is configured for controlling use of the ST mode, the EST mode, and the DEST mode by the current picture. For a value of the first mode flag in the picture header syntax element and semantic content corresponding to different values, refer to Table 3b.

TABLE 3b

| pic_st_flag | Semantics |
|---|---|
| 0 | The ST mode, the EST mode, and the DEST mode |
| | are not allowed to be used. |
| 1 | The ST mode is allowed to be used, and the EST |
| | mode and the DEST mode are not allowed to be used. |
| 2 | The ST mode and the EST mode are allowed to be |
| | used, but the DEST mode is not allowed to be used. |
| 3 | The ST mode, the EST mode, and the DEST mode are |
| | allowed to be used. |

For logic of decoding the foregoing picture header flag, refer to content in Table 3b-1:

TABLE 3b-1

| | |
|---|---|
| pic_st_flag | u(n) |

n = ceil(log2(number of modes)). For example, n = ceil(log2(4)) = 2.

The picture-header ST flag (pic_st_flag) represents the ST mode. A value ‘0’ indicates that the ST mode is prohibited from being used. A value greater than ‘0’ indicates that the ST mode is allowed to be used. A value of PicStFlag is equal to the value of pic_st_flag. If pic_st_flag does not exist in the bitstream, the value of PicStFlag is 0.

In still another implementation, the target syntax element is the slice header syntax element (for example, the slice header flag, which can be referred to as slice_flag), a first mode flag included in the slice header syntax element is denoted as slice_st_flag (a slice-header ST flag), and the slice header syntax element is configured for controlling use of the ST mode, the EST mode, and the DEST mode by the current slice. For a value of the first mode flag in the slice header syntax element and semantic content corresponding to different values, refer to Table 3c.

TABLE 3c

| slice_st_flag | Semantics |
|---|---|
| 0 | The ST mode, the EST mode, and the DEST mode |
| | are not allowed to be used. |
| 1 | The ST mode is allowed to be used, and the EST |
| | mode and the DEST mode are not allowed to be used. |
| 2 | The ST mode and the EST mode are allowed to be |
| | used, but the DEST mode is not allowed to be used. |
| 3 | The ST mode, the EST mode, and the DEST mode |
| | are allowed to be used. |

For logic of decoding the foregoing slice header flag, refer to content in Table 3c-1:

TABLE 3c-1

| | |
|---|---|
| slice_st_flag | u(n) |

n = ceil(log2(number of modes)). For example, n = ceil(log2(4)) = 2.

The slice-header ST flag (slice_st_flag) represents the ST mode. A value ‘0’ indicates that the ST mode is prohibited from being used. A value greater than ‘0’ indicates that the ST mode is allowed to be used. A value of SliceStFlag is equal to the value of slice_st_flag. If slice_st_flag does not exist in the bitstream, the value of SliceStFlag is 0.

Mode 2: (i) If a value of the first mode flag is a first value, the target syntax element indicates that the current object is prohibited from using the ST mode, the EST mode, and the DEST mode. (ii) If a value of the first mode flag is a second value, the target syntax element indicates that the current object is allowed to use the ST mode but is prohibited from using the EST mode and the DEST mode. (iii) If a value of the first mode flag is a third value, the target syntax element indicates that the current object is allowed to use the ST mode, the EST mode, and the DEST mode.

In this mode, the first mode flag included in the target syntax element has only three values. The ST mode and the EST mode are bound together to be controlled, for example, both the ST mode and the EST mode are allowed to be used, or both the ST mode and the EST mode are not allowed to be used. When both the ST mode and the EST mode are allowed to be used, use of the DEST mode can be flexibly controlled based on different values of the first mode flag. When the ST mode is not allowed to be used, both the EST mode and the DEST mode are prohibited from being used.

In an implementation, the target syntax element is the sequence header syntax element (for example, the sequence header flag, which can be referred to as seq_flag), and a first mode flag included in the sequence header syntax element is denoted as seq_st_flag (a sequence-header ST flag). The sequence header syntax element is configured for controlling use of the ST mode, the EST mode, and the DEST mode by the current video sequence. For a value of the first mode flag in the sequence header syntax element and semantic content corresponding to different values, refer to Table 4a.

TABLE 4a

| seq_st_flag | Semantics |
|---|---|
| 0 | The ST mode, the EST mode, and the DEST mode |
| | are not allowed to be used. |
| 1 | The ST mode and the EST mode are allowed to be |
| | used, and the DEST mode is not allowed to be used. |
| 2 | The ST mode, the EST mode, and the DEST mode are |
| | allowed to be used. |

For logic of decoding the foregoing sequence header flag, refer to content in Table 4a-1:

TABLE 4a-1

| | |
|---|---|
| seq_st_flag | ue(v) |

v indicates that variable length coding is used.

The sequence-header ST flag (seq_st_flag) represents the ST mode. A value ‘0’ indicates that the ST mode is prohibited from being used. A value greater than ‘0’ indicates that the ST mode is allowed to be used. A value of SeqStFlag is equal to the value of seq_st_flag. If seq_st_flag does not exist in the bitstream, the value of SeqStFlag is 0.

In another implementation, the target syntax element is the picture header syntax element (for example, the picture header flag, which can be referred to as pic_flag), a first mode flag included in the picture header syntax element is denoted as pic_st_flag (a picture-header ST flag), and the picture header syntax element is configured for controlling use of the ST mode, the EST mode, and the DEST mode by the current picture. For a value of the first mode flag in the picture header syntax element and semantic content corresponding to different values, refer to Table 4b.

TABLE 4b

| pic_st_flag | Semantics |
|---|---|
| 0 | The ST mode, the EST mode, and the DEST mode |
| | are not allowed to be used. |
| 1 | The ST mode and the EST mode are allowed to be |
| | used, and the DEST mode is not allowed to be used. |
| 2 | The ST mode, the EST mode, and the DEST mode |
| | are allowed to be used. |

For logic of decoding the foregoing picture header flag, refer to content in Table 4b-1:

TABLE 4b-1

| | |
|---|---|
| pic_st_flag | ue(v) |

v indicates that variable length coding is used.

The picture-header ST flag (pic_st_flag) represents the ST mode. A value ‘0’ indicates that the ST mode is prohibited from being used. A value greater than ‘0’ indicates that the ST mode is allowed to be used. A value of PicStFlag is equal to the value of pic_st_flag. If pic_st_flag does not exist in the bitstream, the value of PicStFlag is 0.

In still another implementation, the target syntax element is the slice header syntax element (for example, the slice header flag, which can be referred to as slice_flag), a first mode flag included in the slice header syntax element is denoted as slice_st_flag (a slice-header ST flag), and the slice header syntax element is configured for controlling use of the ST mode, the EST mode, and the DEST mode by the current slice. For a value of the first mode flag in the slice header syntax element and semantic content corresponding to different values, refer to Table 4c.

TABLE 4c

| slice_st_flag | Semantics |
|---|---|
| 0 | The ST mode, the EST mode, and the DEST |
| | mode are not allowed to be used. |
| 1 | The ST mode and the EST mode are allowed to be |
| | used, and the DEST mode is not allowed to be used. |
| 2 | The ST mode, the EST mode, and the DEST |
| | mode are allowed to be used. |

For logic of decoding the foregoing slice flag, refer to content in Table 4c-1:

TABLE 4c-1

| | |
|---|---|
| slice_st_flag | ue(v) |

v indicates that variable length coding is used.

The slice-header ST flag (slice_st_flag) represents the ST mode. A value ‘0’ indicates that the ST mode is prohibited from being used. A value greater than ‘0’ indicates that the ST mode is allowed to be used. A value of SliceStFlag is equal to the value of slice_st_flag. If slice_st_flag does not exist in the bitstream, the value of SliceStFlag is 0.

It can be learned that when the target syntax element includes only one mode flag, a value of the mode flag may be configured for controlling use of multiple types of secondary transform modes, so that a corresponding indication is simpler. In addition, compared with the mode 2, the mode 1 has more diversified control modes. Compared with the mode 2, the mode 1 has higher flexibility in controlling the use of various secondary transform modes.

(2) The target syntax element includes a reference mode flag and a third mode flag (dest_flag), where the reference mode flag is a first mode flag (st_flag) or a second mode flag (est_flag). When the target syntax element includes two mode flags (st_flag and dest_flag, or est_flag and dest_flag), the reference mode flag (st_flag or est_flag) is configured for controlling use of the ST mode and the EST mode by the current object, and the third mode flag is configured for controlling use of the DEST mode by the current object. Uses of multiple types of secondary transform modes may be jointly controlled by the reference mode flag and the third mode flag. Based on this, when different mode flags included in the target syntax element have different value combinations, the target syntax element has different control functions, in other words, corresponds to different semantic content. For example, there are the following several cases: (2.1) to (2.3).

(2.1) If a value of the reference mode flag is a first value, the target syntax element indicates that the current object is prohibited from using the ST mode, the EST mode, and the DEST mode.

In an example of an implementation, when the value of the reference mode flag is the first value (for example, a value “0”), the reference mode flag indicates that the current object is prohibited from using the ST mode and the EST mode. Based on a relationship among the ST mode, the EST mode, and the DEST mode, when the ST mode and the EST mode are prohibited from being used, the DEST mode cannot be used either. Therefore, the target syntax element not only indicates that the current object is prohibited from using the ST mode and the EST mode, but also indicates that the current object is prohibited from using the DEST mode.

In addition, when the value of the reference mode flag is the first value (for example, the value “0”), because both the ST mode and the EST mode are prohibited from being used, regardless of how the third mode flag configured for controlling the use of the DEST mode is set, the DEST mode is prohibited from being used. Therefore, to avoid a waste of unnecessary decoding resources, in this disclosure, a value of the third mode flag may be a target character (for example, “x”), to indicate that the third mode flag does not need to be decoded. In other words, the third mode flag does not need to be decoded when the value of the reference mode flag is the first value. When a value of any mode flag is the target character, in addition to controlling use of some transform modes, the target syntax element further indicates that the mode flag does not need to be decoded.

(2.2) If a value of the reference mode flag is a second value, and a value of the third mode flag is a first value, the target syntax element indicates that the current object is allowed to use the ST mode and the EST mode, but is prohibited from using the DEST mode.

In an example of an implementation, when the value of the reference mode flag is the second value (for example, a value “1”), the reference mode flag indicates that the current object is allowed to use the ST mode and the EST mode. When the value of the third mode flag is the first value (for example, a value “0”), the third mode flag indicates that the current object is prohibited from using the DEST mode. Therefore, under a joint action of the two mode flags, the target syntax element indicates that the current object is allowed to use the ST mode and the EST mode, but is prohibited from using the DEST mode.

(2.3) If a value of the reference mode flag is a second value, and a value of the third mode flag is the second value, the target syntax element indicates that the current object is allowed to use the ST mode, the EST mode, and the DEST mode.

In an example of an implementation, when the values of the reference mode flag and the third mode flag are both the second value (for example, a value “1”), the reference mode flag indicates that the current object is allowed to use the ST mode and the EST mode, and the third mode flag indicates that the current object is allowed to use the DEST mode. Therefore, under a joint action of the two mode flags, the target syntax element indicates that the current object is allowed to use the ST mode, the EST mode, and the DEST mode.

The following summarizes the several cases described in (2.1) to (2.3) by substituting corresponding syntax elements. In an implementation, the target syntax element is the sequence header syntax element (for example, the sequence header flag, which can be referred to as seq_flag), and a reference mode flag included in the sequence header syntax element may be configured for controlling use of the ST mode and the EST mode by the current video sequence. When the reference mode flag is the first mode flag, the reference mode flag may be denoted as seq_st_flag (a sequence-header ST flag). When the reference mode flag is the second mode flag, the reference mode flag may be denoted as seq_est_flag (a sequence-header EST flag). A third mode flag included in the sequence header syntax element indicates use of the DEST mode by the current video sequence. In this case, the third mode flag may be denoted as seq_dest_flag (a sequence-header DEST flag). Based on this, values of the two mode flags and corresponding semantic content enumerated in Table 5a are provided below by using an example in which the reference mode flag is the first mode flag.

TABLE 5a

| | seq_dest_ | |
|---|---|---|
| seq_st_flag | flag | Semantics |
| 0 | x | The ST mode, the EST mode, and the DEST mode are not |
| | | allowed to be used. |
| 1 | 0 | The ST mode and the EST mode are allowed to be used, and the |
| | | DEST mode is not allowed to be used. |
| 1 | 1 | The ST mode, the EST mode, and the DEST mode are allowed |
| | | to be used. |

For logic of decoding the foregoing sequence header flag, refer to content in Table 5a-1:

TABLE 5a-1

| | |
|---|---|
| seq_st_flag | u(1) |
| if(SeqStFlag) { | |
| seq_dest_flag | u(1) |
| } | |

The sequence-header ST flag (seq_st_flag) is a binary variable. A value ‘l’ indicates that the ST mode is allowed to be used. A value ‘0’ indicates that the ST mode is prohibited from being used. A value of SeqStFlag is equal to the value of seq_st_flag. If seq_st_flag does not exist in the bitstream, the value of SeqStFlag is 0.

The sequence-header DEST flag (seq_dest_flag) is a binary variable. A value ‘1’ indicates that the DEST mode is allowed to be used. A value ‘0’ indicates that the DEST mode is prohibited from being used. A value of SeqDestFlag is equal to the value of seq_dest_flag. If seq_dest_flag does not exist in the bitstream, the value of SeqDestFlag is 0.

In another implementation, the target syntax element is the picture header syntax element (for example, the picture header flag, which can be referred to as pic_flag), and a reference mode flag included in the picture header syntax element may be configured for controlling use of the ST mode and the EST mode by the current picture. When the reference mode flag is the first mode flag, the reference mode flag may be denoted as pic_st_flag (a picture-header ST flag). When the reference mode flag is the second mode flag, the reference mode flag may be denoted as pic_est_flag (the picture-header EST flag). A third mode flag included in the picture header syntax element indicates use of the DEST mode by the current picture. In this case, the third mode flag may be denoted as pic_dest_flag (a picture-header DEST flag). Based on this, values of the two mode flags and corresponding semantic content enumerated in Table 5b are provided below by using an example in which the reference mode flag is the first mode flag (for example, pic_st_flag).

TABLE 5b

| pic_st_flag | pic_dest_flag | Semantics |
|---|---|---|
| 0 | x | The ST mode, the EST mode, and the DEST mode are not |
| | | allowed to be used. |
| 1 | 0 | The ST mode and the EST mode are allowed to be used, and the |
| | | DEST mode is not allowed to be used. |
| 1 | 1 | The ST mode, the EST mode, and the DEST mode are allowed |
| | | to be used. |

For logic of decoding the foregoing picture header flag, refer to content in Table 5b-1:

TABLE 5b-1

| | |
|---|---|
| pic_st_flag | u(1) |
| if(PicStFlag) { | |
| pic_dest_flag | u(1) |
| } | |

The picture-header ST flag (pic_st_flag) is a binary variable. A value ‘l’ indicates that the ST mode is allowed to be used. A value ‘0’ indicates that the ST mode is prohibited from being used. A value of PicStFlag is equal to the value of pic_st_flag. If pic_st_flag does not exist in the bitstream, the value of PicStFlag is 0.

The picture-header DEST flag (pic_dest_flag) is a binary variable. A value ‘1’ indicates that the DEST mode is allowed to be used. A value ‘0’ indicates that the DEST mode is prohibited from being used. A value of PicDestFlag is equal to the value of pic_dest_flag. If pic_dest_flag does not exist in the bitstream, the value of PicDestFlag is 0.

If the reference mode flag is the second mode flag (for example, pic_est_flag), a value and semantics corresponding to the reference mode flag are the same as those in Table 5b, and logic of decoding pic_est_flag and pic_dest_flag included in the picture header flag is similar to the logic enumerated in Table 5b-1, as enumerated in Table 5b-2:

TABLE 5b-2

| | |
|---|---|
| pic_est_flag | u(1) |
| if(PicEstFlag) { | |
| pic_dest_flag | u(1) |
| } | |

The picture-header EST flag (pic_est_flag) is a binary variable. A value ‘1’ indicates that the EST mode is allowed to be used. A value ‘0’ indicates that the EST mode is prohibited from being used. A value of PicStFlag is equal to the value of pic_est_flag. If pic_est_flag does not exist in the bitstream, the value of PicStFlag is 0.

The picture-header DEST flag (pic_dest_flag) is a binary variable. A value ‘1’ indicates that the DEST mode is allowed to be used. A value ‘0’ indicates that the DEST mode is prohibited from being used. A value of PicDestFlag is equal to the value of pic_dest_flag. If pic_dest_flag does not exist in the bitstream, the value of PicDestFlag is 0.

In still another implementation, the target syntax element is the slice header syntax element (for example, the slice header flag, which can be referred to as slice_flag), and a reference mode flag included in the slice header syntax element may be configured for controlling use of the ST mode and the EST mode by the current slice. When the reference mode flag is the first mode flag, the reference mode flag may be denoted as slice_st_flag (a slice-header ST flag). When the reference mode flag is the second mode flag, the reference mode flag may be denoted as slice_est_flag (a slice-header EST flag). A third mode flag included in the slice header syntax element indicates use of the DEST mode by the current slice. In this case, the third mode flag may be denoted as slice_dest_flag (a slice-header DEST flag). Based on this, values of the two mode flags and corresponding semantic content enumerated in Table 5c are provided below by using an example in which the reference mode flag is the first mode flag.

TABLE 5c

| slice_st_flag | slice_dest_flag | Semantics |
|---|---|---|
| 0 | x | The ST mode, the EST mode, and |
| | | the DEST mode are not allowed |
| | | to be used. |
| 1 | 0 | The ST mode and the EST mode |
| | | are allowed to be used, and the |
| | | DEST mode is not allowed to be used. |
| 1 | 1 | The ST mode, the EST mode, and the |
| | | DEST mode are allowed to be used. |

For logic of decoding the foregoing slice flag, refer to content in Table 5c-1:

TABLE 5c-1

| | |
|---|---|
| slice_st_flag | u(1) |
| if(SliceStFlag) { | |
| slice_dest_flag | u(1) |
| } | |

The slice-header ST flag (slice_st_flag) is a binary variable. A value ‘l’ indicates that the ST mode is allowed to be used. A value ‘0’ indicates that the ST mode is prohibited from being used. A value of SliceStFlag is equal to the value of slice_st_flag. If slice_st_flag does not exist in the bitstream, the value of SliceStFlag is 0.

The slice-header DEST flag (slice_dest_flag) is a binary variable. A value ‘1’ indicates that the DEST mode is allowed to be used. A value ‘0’ indicates that the DEST mode is prohibited from being used. A value of SliceDestFlag is equal to the value of slice_dest_flag. If slice_dest_flag does not exist in the bitstream, the value of SliceDestFlag is 0.

If a value of the third mode flag (dest_flag) included in each of the foregoing syntax elements is the character x, the third mode flag does not need to be decoded. This is because: When the ST mode or the EST mode is not allowed to be used, the DEST mode is not allowed to be used either. Even if the value of the third mode flag is the second value to allow the DEST mode to be used, the DEST mode cannot be actually used. Therefore, to avoid unnecessary decoding and save decoding resources, the value of the third mode flag may be set to the target character, to explicitly indicate that the third mode flag does not need to be decoded.

(3) The target syntax element includes a first mode flag (st_flag), a second mode flag (est_flag), and a third mode flag (dest_flag). On the premise that the target syntax element includes the three mode flags, each mode flag may be configured for controlling use of one type of secondary transform mode by the current object. For example, the first mode flag is configured for controlling use of the ST mode by the current object, the second mode flag is configured for controlling use of the EST mode by the current object, and the third mode flag is configured for controlling use of the DEST mode by the current object. Based on this, under a joint action of the three mode flags, the target syntax element has different control functions based on different value combinations of the mode flags. For details, refer to content described in (3.1) to (3.4).

(3.1) If a value of the first mode flag is a first value, the target syntax element indicates that the current object is prohibited from using the ST mode, the EST mode, and the DEST mode.

In an example of an implementation, if the value of the first mode flag is the first value (for example, a value “0”), the first mode flag has the following control function: The first mode flag indicates that the current object is prohibited from using the ST mode. Based on a relationship among the ST mode, the EST mode, and the DEST mode, when the ST mode is prohibited from being used, the EST mode is prohibited from being used. As a result, the DEST mode is also prohibited from being used. Therefore, the target syntax element indicates that the current object is prohibited from using the ST mode, the EST mode, and the DEST mode.

When the value of the first mode flag is the first value (for example, the value “0”), because both the EST mode and the DEST mode cannot be used, to avoid wasting resources to decode another mode flag, values of both the second mode flag for controlling the use of the EST mode and the third mode flag for controlling the use of the DEST mode may be a target character (for example, “x”), to indicate that neither the second mode flag nor the third mode flag needs to be decoded. In other words, when the value of the first mode flag is the first value, in addition to controlling use of some transform modes, the target syntax element further indicates that the second mode flag and the third mode flag do not need to be decoded.

(3.2) If a value of the first mode flag is a second value, and a value of the second mode flag is a first value, the target syntax element indicates that the current object is allowed to use the ST mode, but is prohibited from using the EST mode and the DEST mode.

In an example of an implementation, when the value of the first mode flag is the second value (for example, a value “1”), the first mode flag indicates that the current object is allowed to use the ST mode. Based on a relationship among the ST mode, the EST mode, and the DEST mode, when the ST mode is allowed to be used, whether the EST mode and the DEST mode are allowed to be used may be flexibly controlled by using values of the corresponding mode flags. If the value of the second mode flag is the first value (for example, a value “0”), the second mode flag indicates that the current object is prohibited from using the EST mode, in other words, the EST mode is prohibited from being used, so that it can be directly determined that the DEST mode is prohibited from being used. Therefore, the target syntax element indicates that the current object is allowed to use the ST mode but is prohibited from using the EST mode and the DEST mode.

In addition, when the value of the second mode flag is the first value (for example, the value “0”), because the DEST mode cannot be used when the EST mode is prohibited from being used, to avoid wasting resources to decode another mode flag, a value of the third mode flag may be a target character (for example, “x”), to indicate that the third mode flag does not need to be decoded. In other words, when the value of the first mode flag is the second value (for example, the value “1”), and the value of the second mode flag is the first value (for example, the value “0”), in addition to controlling use of some transform modes, the target syntax element further indicates that the third mode flag does not need to be decoded.

(3.3) If values of both the first mode flag and the second mode flag are a second value, and a value of the third mode flag is a first value, the target syntax element indicates that the current object is allowed to use the ST mode and the EST mode, but is prohibited from using the DEST mode.

In an example of an implementation, when the value of the first mode flag is the second value (for example, a value “1”), the first mode flag indicates that the current object is allowed to use the ST mode. When the value of the second mode flag is the second value (for example, the value “1”), the second mode flag indicates that the current object is allowed to use the EST mode. Based on a relationship among the ST mode, the EST mode, and the DEST mode, when both the ST mode and the EST mode are allowed to be used, whether the DEST mode is allowed to be used may be flexibly controlled by using the value of the third mode flag. If the value of the third mode flag is the first value (for example, a value “0”), the third mode flag indicates that the current object is prohibited from using the DEST mode. In combination with control functions of the foregoing three mode flags, the target syntax element indicates that the current object is allowed to use the ST mode and the EST mode, but is prohibited from using the DEST mode.

(3.4) If values of both the first mode flag and the second mode flag are a second value, and a value of the third mode flag is the second value, the target syntax element indicates that the current object is allowed to use the ST mode, the EST mode, and the DEST mode.

If the values of the first mode flag and the second mode flag are both the second value (for example, a value “1”), under a joint action, the two mode flags may indicate that the current object is allowed to use the ST mode and the EST mode. This is similar to (3.3). Whether the DEST mode is allowed to be used may be flexibly controlled by using the value of the third mode flag. When the value of the third mode flag is also the second value (for example, the value “1”), the third mode flag indicates that the current object is allowed to use the DEST mode. Therefore, by using the values of the foregoing three mode flags, the target syntax element indicates that the current object is allowed to use the ST mode, the EST mode, and the DEST mode.

The following describes the several cases described in (3.1) to (3.4) by substituting different syntax elements. In an implementation, the target syntax element is the sequence header syntax element (seq_flag), and a first mode flag included in the sequence header syntax element is configured for controlling use of the ST mode by the current video sequence. In this case, the first mode flag may be denoted as seq_st_flag (for example, a sequence-header ST flag). A second mode flag included in the sequence header syntax element is configured for controlling use of the EST mode by the current video sequence. In this case, the second mode flag may be denoted as seq_est_flag (for example, a sequence-header EST flag). A third mode flag included in the sequence header syntax element is configured for controlling use of the DEST mode by the current video sequence. In this case, the third mode flag may be denoted as seq_dest_flag (for example, a sequence-header DEST flag). Based on this, different values of the three mode flags and corresponding semantic content enumerated in Table 6a are provided.

TABLE 6a

| seq_ | seq_est_ | seq_dest_ | |
|---|---|---|---|
| st_flag | flag | flag | Semantics |
| 0 | x | x | The ST mode, the EST mode, and the |
| | | | DEST mode are not allowed to be used. |
| 1 | 0 | 0 | The ST mode is allowed to be used, and |
| | | | the EST mode and the DEST mode are not |
| | | | allowed to be used. |
| 1 | 1 | 0 | The ST mode and the EST mode are |
| | | | allowed to be used, but the DEST mode |
| | | | is not allowed to be used. |
| 1 | 1 | 1 | The ST mode, the EST mode, and the |
| | | | DEST mode are allowed to be used. |

For logic of decoding the foregoing sequence header flag, refer to content in Table 6a-1:

TABLE 6a-1

| | |
|---|---|
| seq_st_flag | u(1) |
| if(SeqStFlag) { | |
| seq_est_flag | u(1) |
| if(SeqEstFlag) { | |
| seq_dest_flag | |
| } | |
| } | |

The sequence-header ST flag (seq_st_flag) is a binary variable. A value ‘l’ indicates that the ST mode is allowed to be used. A value ‘0’ indicates that the ST mode is prohibited from being used. A value of SeqStFlag is equal to the value of seq_st_flag. If seq_st_flag does not exist in the bitstream, the value of SeqStFlag is 0.

The sequence-header EST flag (eq_est_flag) is a binary variable. A value ‘1’ indicates that the EST mode is allowed to be used. A value ‘0’ indicates that the EST mode is prohibited from being used. A value of SeqEstFlag is equal to the value of seq_est_flag. If seq_est_flag does not exist in the bitstream, the value of SeqEstFlag is 0.

The sequence-header DEST flag (seq_dest_flag) is a binary variable. A value ‘1’ indicates that the DEST mode is allowed to be used. A value ‘0’ indicates that the DEST mode is prohibited from being used. A value of SeqDestFlag is equal to the value of seq_dest_flag. If seq_dest_flag does not exist in the bitstream, the value of SeqDestFlag is 0.

In another implementation, the target syntax element is the picture header syntax element (for example, the picture header flag, which can be referred to as pic_flag), and a first mode flag included in the picture header syntax element is configured for controlling use of the ST mode by the current picture. In this case, the first mode flag may be denoted as pic_st_flag (for example, a picture-header ST flag). A second mode flag included in the picture header syntax element is configured for controlling use of the EST mode by the current picture. In this case, the second mode flag may be denoted as pic_est_flag (for example, a picture-header EST flag). A third mode flag included in the picture header syntax element is configured for controlling use of the DEST mode by the current picture. In this case, the third mode flag may be denoted as pic_dest_flag (for example, a picture-header DEST flag). Based on this, different values of the three mode flags and specific semantic content enumerated in Table 6b are provided.

TABLE 6b

| pic_ | pic_est_ | pic_ | |
|---|---|---|---|
| st_flag | flag | dest_flag | Semantics |
| 0 | x | x | The ST mode, the EST mode, and the |
| | | | DEST mode are not allowed to be used. |
| 1 | 0 | 0 | The ST mode is allowed to be used, and |
| | | | the EST mode and the DEST mode are |
| | | | not allowed to be used. |
| 1 | 1 | 0 | The ST mode and the EST mode are |
| | | | allowed to be used, but the DEST mode |
| | | | is not allowed to be used. |
| 1 | 1 | 1 | The ST mode, the EST mode, and the |
| | | | DEST mode are allowed to be used. |

For logic of decoding the foregoing picture header flag, refer to content in Table 6b-1:

TABLE 6b-1

| | |
|---|---|
| pic_st_flag | u(1) |
| if(PicStFlag) { | |
| pic_est_flag | u(1) |
| if(PicEstFlag) { | |
| pic_dest_flag | |
| } | |
| } | |

The picture-header ST flag (pic_st_flag) is a binary variable. A value ‘l’ indicates that the ST mode is allowed to be used. A value ‘0’ indicates that the ST mode is prohibited from being used. A value of PicStFlag is equal to the value of pic_st_flag. If pic_st_flag does not exist in the bitstream, the value of PicStFlag is 0.

The picture-header EST flag (eq_est_flag) is a binary variable. A value ‘1’ indicates that the EST mode is allowed to be used. A value ‘0’ indicates that the EST mode is prohibited from being used. A value of PicEstFlag is equal to the value of pic_est_flag. If pic_est_flag does not exist in the bitstream, the value of PicEstFlag is 0.

The picture-header DEST flag (pic_dest_flag) is a binary variable. A value ‘l’ indicates that the DEST mode is allowed to be used. A value ‘0’ indicates that the DEST mode is prohibited from being used. A value of PicDestFlag is equal to the value of pic_dest_flag. If pic_dest_flag does not exist in the bitstream, the value of PicDestFlag is 0.

In still another implementation, the target syntax element is the slice header syntax element (for example, the slice header flag, which can be referred to as slice_flag), and a first mode flag included in the slice header syntax element is configured for controlling use of the ST mode by the current slice. In this case, the first mode flag may be denoted as slice_st_flag (for example, a slice-header ST flag). A second mode flag included in the slice header syntax element is configured for controlling use of the EST mode by the current slice. In this case, the second mode flag may be denoted as slice_est_flag (for example, a slice-header EST flag). A third mode flag included in the slice header syntax element is configured for controlling use of the DEST mode by the current slice. In this case, the third mode flag may be denoted as slice_dest_flag (for example, a slice-header DEST flag). Based on this, different values of the three mode flags and specific semantic content enumerated in Table 6c are provided.

TABLE 6c

| | slice_est_ | | |
|---|---|---|---|
| slice_st_flag | flag | slice_dest_flag | Semantics |
| 0 | x | x | The ST mode, the EST mode, and the DEST |
| | | | mode are not allowed to be used. |
| 1 | 0 | 0 | The ST mode is allowed to be used, and the |
| | | | EST mode and the DEST mode are not allowed |
| | | | to be used. |
| 1 | 1 | 0 | The ST mode and the EST mode are allowed |
| | | | to be used, but the DEST mode is not allowed |
| | | | to be used. |
| 1 | 1 | 1 | The ST mode, the EST mode, and the DEST |
| | | | mode are allowed to be used. |

For logic of decoding the foregoing slice flag, refer to content in Table 6c-1:

TABLE 6c-1

| | |
|---|---|
| slice_st_flag | u(1) |
| if(SliceStFlag) { | |
| slice_est_flag | u(1) |
| if(SliceEstFlag) { | |
| slice_dest_flag | |
| } | |
| } | |

The slice-header ST flag (slice_st_flag) is a binary variable. A value ‘l’ indicates that the ST mode is allowed to be used. A value ‘0’ indicates that the ST mode is prohibited from being used. A value of SliceStFlag is equal to the value of slice_st_flag. If slice_st_flag does not exist in the bitstream, the value of SliceStFlag is 0.

The slice-header EST flag (eq_est_flag) is a binary variable. A value ‘l’ indicates that the EST mode is allowed to be used. A value ‘0’ indicates that the EST mode is prohibited from being used. A value of SliceEstFlag is equal to the value of slice_est_flag. If slice_est_flag does not exist in the bitstream, the value of SliceEstFlag is 0.

The slice-header DEST flag (slice_dest_flag) is a binary variable. A value ‘1’ indicates that the DEST mode is allowed to be used. A value ‘0’ indicates that the DEST mode is prohibited from being used. A value of SliceDestFlag is equal to the value of slice_dest_flag. If slice_dest_flag does not exist in the bitstream, the value of SliceDestFlag is 0.

It can be learned that, in the foregoing tables, when any syntax element includes multiple mode flags, use of various types of secondary transform modes can be more finely controlled based on values of the multiple mode flags, thereby further improving flexibility in the use of the various types of secondary transform modes.

In an aspect, when the transform mode syntax control information includes multiple syntax elements, and a syntax element at a lower level includes only one mode flag, decoding of the syntax element at the lower level needs to depend on a syntax element at a higher level. Herein, the higher and lower levels of the syntax elements are relative, and for example are determined based on levels of syntax structures on which the syntax elements function. For example, the transform mode syntax control information includes the sequence header syntax element and the picture header syntax element, where the sequence header syntax element functions on the current video sequence, and a functioned syntax structure is a video sequence; and the picture header syntax element functions on the current picture, and a functioned syntax structure is a picture. Because a level of the video sequence is higher than a level of the picture, the sequence header syntax element is a syntax element at a higher level, and the picture header syntax element is a syntax element at a lower level.

The following uses an example in which the transform mode syntax control information includes two syntax elements, to describe dependency between syntax elements that are set in syntax structures of different levels. The transform mode syntax control information includes a first syntax element and a second syntax element, and a level of a syntax structure on which the second syntax element functions is higher than a level of a syntax structure on which the first syntax element functions. For example, the second syntax element is the sequence header syntax element (seq_flag), and the first syntax element is the picture header syntax element (pic_flag). For another example, the second syntax element is the picture header syntax element (pic_flag), and the first syntax element is the slice header syntax element (slice_flag). For still another example, the second syntax element is the sequence header syntax element (seq_flag), and the first syntax element is the slice header syntax element (slice_flag).

The first syntax element includes a third mode flag, and the third mode flag in the first syntax element is configured for controlling use of the DEST mode by a first object. For example, whether the first object is allowed to use or prohibited from using the DEST mode may be indicated based on different values of the third mode flag. The second syntax element includes one or more of a first mode flag, a second mode flag, and a third mode flag, the first mode flag in the second syntax element is configured for controlling use of the ST mode by a second object, the second mode flag in the second syntax element is configured for controlling use of the EST mode by the second object, and the third mode flag in the second syntax element is configured for controlling use of the DEST mode by the second object.

If the first syntax element is the picture header syntax element, the first object is the current picture, the second syntax element is the sequence header syntax element, and the second object is the current video sequence. If the first syntax element is the slice header syntax element, the first object is the current slice, the second syntax element is the picture header syntax element, and the second object is the current picture. If the first syntax element is the slice header syntax element, the first object is the current slice, the second syntax element is the sequence header syntax element, and the second object is the current video sequence. It can be learned from the foregoing that, a level of a syntax structure corresponding to the second object is higher than a level of a syntax structure corresponding to the first object.

When the first syntax element includes only one mode flag (which is the third mode flag herein), the third mode flag in the first syntax element depends on any mode flag in the second syntax element. In an implementation, if the second syntax element includes only one mode flag (for example, any one of the first mode flag, the second mode flag, and the third mode flag), the third mode flag in the first syntax element may depend on the mode flag included in the second syntax element. In another implementation, if the second syntax element includes two or more mode flags (for example, the first mode flag and the second mode flag, the first mode flag and the third mode flag, the second mode flag and the third mode flag, or all of the first mode flag, the second mode flag, and the third mode flag), the third mode flag in the first syntax element may depend on any one (for example, the first mode flag or the second mode flag) of the multiple mode flags included in the second syntax element.

Dependency between the mode flags in the first syntax element and the second syntax element may be in the following I to III cases.

I The second syntax element includes the first mode flag, and that the third mode flag in the first syntax element depends on the first mode flag in the second syntax element includes the following content:

(I-1) If a value of the first mode flag in the second syntax element is a first value, the transform mode syntax control information indicates that the first object is prohibited from using the ST mode, the EST mode, and the DEST mode.

For example, if the value of the first mode flag in the second syntax element is the first value (for example, a value “0”), the second syntax element indicates that the second object is prohibited from using the ST mode. Because the level of the syntax structure corresponding to the second object is higher than the level of the syntax structure corresponding to the first object, when the second object is prohibited from using the ST mode, the first object is also prohibited from using the ST mode, the EST mode, and the DEST mode. Therefore, the transform mode syntax control information may indicate that the first object is prohibited from using the ST mode, the EST mode, and the DEST mode.

When a syntax element at a higher level prohibits use of the ST mode, no matter how a mode flag in a syntax element at a lower level is set, a syntax structure at the lower level is not allowed to use the ST mode, the EST mode, and the DEST mode. To avoid unnecessary decoding of the third mode flag and save decoding resources, a value of the third mode flag may be set to a target character (for example, a character “x”), so that the transform mode syntax control information may further indicate that the third mode flag does not need to be decoded.

(I-2) If a value of the first mode flag in the second syntax element is a second value, and a value of the third mode flag in the first syntax element is a first value, the transform mode syntax control information indicates that the first object is allowed to use the ST mode and the EST mode, but is prohibited from using the DEST mode.

For example, if the value of the first mode flag in the second syntax element is the second value (for example, a value “1”), the second syntax element indicates that the second object is allowed to use the ST mode. When the second object at a higher level is allowed to use the ST mode, the first object at a lower level may be allowed to use the ST mode, the EST mode, and the DEST mode, and whether the first object is allowed to use the DEST mode may be finally determined by using the value of the third mode flag in the first syntax element. In this mode, if the value of the third mode flag in the first syntax element is the first value (for example, a value “0”), the first object is prohibited from using the DEST mode. Therefore, under a joint action of the first syntax element and the second syntax element, the transform mode syntax control information may indicate that the first object is allowed to use the ST mode and the EST mode, but is prohibited from using the DEST mode.

(I-3) If a value of the first mode flag in the second syntax element is a second value, and a value of the third mode flag in the first syntax element is the second value, the transform mode syntax control information indicates that the first object is allowed to use the ST mode, the EST mode, and the DEST mode.

For example, if the value of the first mode flag in the second syntax element is the second value (for example, a value “1”), the second syntax element indicates that the second object is allowed to use the ST mode. When the second object at a higher level is allowed to use the ST mode, the first object at a lower level may be allowed to use the ST mode, the EST mode, and the DEST mode, and whether the first object is allowed to use the DEST mode may be finally determined by using the value of the third mode flag in the first syntax element. In this mode, if the value of the third mode flag in the first syntax element is the second value (for example, the value “1”), the first object is allowed to use the DEST mode. Therefore, under a joint action of the first syntax element and the second syntax element, the transform mode syntax control information may indicate that the first object is allowed to use the ST mode, the EST mode, and the DEST mode.

For better understanding, the following provides values of corresponding mode flags in different syntax elements and corresponding semantic content that are enumerated in Table 7a, Table 7b, and Table 7c. In an implementation, if the first syntax element is the picture header syntax element (pic_flag), the second syntax element is the sequence header syntax element (seq_flag). The third mode flag included in the first syntax element is denoted as pic_dest_flag, and the first mode flag included in the second syntax element is denoted as seq_st_flag. That pic_dest_flag in the picture header syntax element depends on seq_st_flag in the sequence header syntax element may include: decoding of pic_dest_flag depends on seq_st_flag. According to the content described in (I-1) to (I-3) above, content enumerated in Table 7a is correspondingly provided.

TABLE 7a

| seq_st_flag | pic_dest_flag | Semantics |
|---|---|---|
| 0 | x | The ST mode, the EST mode, and the |
| | | DEST mode are not allowed to be used. |
| 1 | 0 | The ST mode and the EST mode are |
| | | allowed to be used, and the DEST mode |
| | | is not allowed to be used. |
| 1 | 1 | The ST mode, the EST mode, and the |
| | | DEST mode are allowed to be used. |

Logic of decoding the first syntax element and the second syntax element may include content in Table 7a-1 and Table 7a-2:

In the sequence header:

TABLE 7a-1

| | |
|---|---|
| seq_st_flag | u(1) |

The sequence-header ST flag (seq_st_flag) represents the ST mode. A value ‘1’ indicates that the ST mode is allowed to be used. A value ‘0’ indicates that the ST mode is prohibited from being used. A value of SeqStFlag is equal to the value of seq_st_flag. If seq_st_flag does not exist in the bitstream, the value of SeqStFlag is 0.

In the picture header:

TABLE 7a-2

| | |
|---|---|
| if(SeqStFlag) { | |
| pic_dest_flag | u(1) |
| } | |

The picture-header DEST flag (pic_dest_flag) is a binary variable. A value ‘1’ indicates that the DEST mode is allowed to be used. A value ‘0’ indicates that the DEST mode is prohibited from being used. A value of PicDestFlag is equal to the value of pic_dest_flag. If pic_dest_flag does not exist in the bitstream, the value of PicDestFlag is 0.

In another implementation, if the first syntax element is the slice header syntax element (slice_flag), the second syntax element is the picture header syntax element (pic_flag). The third mode flag included in the first syntax element is denoted as slice_dest_flag, and the first mode flag included in the second syntax element is denoted as pic_st_flag. That slice_dest_flag in the slice header syntax element depends on pic_st_flag in the picture header syntax element may include: Decoding of slice_dest_flag depends on pic_st_flag. According to the content described in (I-1) to (I-3) above, content enumerated in Table 7b is correspondingly provided.

TABLE 7b

| pic_st_flag | slice_dest_flag | Semantics |
|---|---|---|
| 0 | X | The ST mode, |
| | | the EST mode, |
| | | and the DEST |
| | | mode are not |
| | | allowed to be used. |
| 1 | 0 | The ST mode and |
| | | the EST mode are |
| | | allowed to be used, |
| | | and the DEST mode |
| | | is not allowed |
| | | to be used. |
| 1 | 1 | The ST mode, |
| | | the EST mode, |
| | | and the DEST |
| | | mode are |
| | | allowed to be used. |

For logic of decoding the first syntax element and the second syntax element, refer to content in Table 7b-1 and Table 7b-2:

In the picture header:

TABLE 7b-1

| | |
|---|---|
| pic_st_flag | u(1) |

The picture-header ST flag (pic_st_flag) is a binary variable. A value ‘l’ indicates that the ST mode is allowed to be used. A value ‘0’ indicates that the ST mode is prohibited from being used. A value of PicStFlag is equal to the value of pic_st_flag. If pic_st_flag does not exist in the bitstream, the value of PicStFlag is 0.

In the slice header:

TABLE 7b-2

| | |
|---|---|
| if(PicStFlag) { | |
| slice_dest_flag | u(1) |
| } | |

The slice-header DEST flag (slice_dest_flag) is a binary variable. A value ‘l’ indicates that the DEST mode is allowed to be used. A value ‘0’ indicates that the DEST mode is prohibited from being used. A value of SliceDestFlag is equal to the value of slice_dest_flag. If slice_dest_flag does not exist in the bitstream, the value of SliceDestFlag is 0.

In still another implementation, if the first syntax element is the slice header syntax element (slice_flag), the second syntax element may alternatively be the sequence header syntax element (seq_flag). The third mode flag included in the first syntax element is denoted as slice_dest_flag, and the first mode flag included in the second syntax element is denoted as seq_st_flag. That slice_dest_flag in the slice header syntax element depends on seq_st_flag in the sequence header syntax element may include: Decoding of slice_dest_flag depends on seq_st_flag. According to the content described in (I-1) to (I-3) above, content enumerated in Table 7c is correspondingly provided.

TABLE 7c

| seq_st_flag | slice_dest_flag | Semantics |
|---|---|---|
| 0 | X | The ST mode, |
| | | the EST mode, |
| | | and the DEST |
| | | mode are not |
| | | allowed to be used. |
| 1 | 0 | The ST mode and |
| | | the EST mode are |
| | | allowed to be used, |
| | | and the DEST mode |
| | | is not allowed |
| | | to be used. |
| 1 | 1 | The ST mode, |
| | | the EST mode, |
| | | and the DEST |
| | | mode are allowed |
| | | to be used. |

It can be learned that, in the foregoing tables, if the value of the first mode flag (st_flag) in the second syntax element at the higher level is the value “0”, the first object at the higher level is prohibited from using the ST mode. The second object at the lower level cannot use the ST mode, further cannot use the EST mode, and therefore cannot use the DEST mode. For example, when the value of the first mode flag seq_st_flag in the sequence header syntax element is the value “0”, the first mode flag indicates that the current video sequence is prohibited from using the ST mode. In this case, the current picture and the current slice cannot use the ST mode, the EST mode, and the DEST mode either. For example, if the use of the ST mode is controlled to be prohibited at a sequence level by using a syntax element, the ST mode, the EST mode, and the DEST mode cannot be used at a level (for example, a picture level or a slice level) lower than the sequence level. Therefore, the third mode flag pic_dest_flag in the picture header syntax element does not need to be decoded, and the third mode flag slice_dest_flag in the slice header syntax element does not need to be decoded.

II The second syntax element includes the second mode flag, and that the third mode flag in the first syntax element depends on the second mode flag in the second syntax element may include the following content:

(II-1) If a value of the second mode flag in the second syntax element is a first value, the transform mode syntax control information indicates that the first object is prohibited from using the EST mode and the DEST mode.

For example, if the value of the second mode flag in the second syntax element is the first value (for example, a value “0”), the second syntax element indicates that the second object is prohibited from using the EST mode. Because the level of the syntax structure corresponding to the second object is higher than the level of the syntax structure corresponding to the first object, when the second object is prohibited from using the EST mode, the second object is not allowed to use the EST mode, and the first object is not allowed to use the DEST mode. Therefore, under a joint action of the first syntax element and the second syntax element, the transform mode syntax control information may indicate that the first object is prohibited from using the EST mode and the DEST mode.

When a syntax element at a higher level prohibits use of the EST mode, no matter how a mode flag in a syntax element at a lower level is set, a syntax structure at the lower level is not allowed to use the EST mode and the DEST mode. To avoid unnecessary decoding of the third mode flag and save decoding resources, a value of the third mode flag may be set to a target character (for example, a character “x”), so that the transform mode syntax control information may further indicate that the third mode flag does not need to be decoded.

(II-2) If a value of the second mode flag in the second syntax element is a second value, and a value of the third mode flag in the first syntax element is a first value, the transform mode syntax control information indicates that the first object is allowed to use the ST mode and the EST mode, but is prohibited from using the DEST mode.

For example, if the value of the second mode flag in the second syntax element is the second value (for example, a value “1”), the second syntax element indicates that the second object is allowed to use the EST mode. When the EST mode is allowed, the second object is allowed to use the ST mode. Therefore, when the second object at a higher level is allowed to use the ST mode and the EST mode, the first object at a lower level may be allowed to use the ST mode, the EST mode, and the DEST mode, and whether the first object is allowed to use the DEST mode may be finally determined by using the value of the third mode flag in the first syntax element. In this mode, if the value of the third mode flag in the first syntax element is the first value (for example, a value “0”), the first object is prohibited from using the DEST mode. Therefore, under a joint action of the first syntax element and the second syntax element, the transform mode syntax control information may indicate that the first object is allowed to use the ST mode and the EST mode, but is prohibited from using the DEST mode.

(II-3) If a value of the second mode flag in the second syntax element is a second value, and a value of the third mode flag in the first syntax element is the second value, the transform mode syntax control information indicates that the first object is allowed to use the ST mode, the EST mode, and the DEST mode.

If the value of the second mode flag in the second syntax element is the second value (for example, a value “1”), the second syntax element indicates that the second object is allowed to use the EST mode, so that the first object may be allowed to use the ST mode, the EST mode, and the DEST mode. This is similar to (II-2) above. In this mode, if the value of the third mode flag in the first syntax element is the second value (for example, the value “1”), the first object is allowed to use the DEST mode. Therefore, under a joint action of the first syntax element and the second syntax element, the transform mode syntax control information may indicate that the first object is allowed to use the ST mode, the EST mode, and the DEST mode.

Based on the content described in (II-1) to (II(3), the following may provide values of corresponding mode flags in different syntax elements and corresponding semantic content that are enumerated in Table 8a, Table 8b, and Table 8c.

In an implementation, if the first syntax element is the picture header syntax element (pic_flag), the second syntax element is the sequence header syntax element (seq_flag). The third mode flag included in the first syntax element is denoted as pic_dest_flag, and the second mode flag included in the second syntax element is denoted as seq_est_flag. That pic_dest_flag in the picture header syntax element depends on seq_est_flag in the sequence header syntax element may include: decoding of pic_dest_flag depends on seq_est_flag. According to the content described in (II-1) to (II-3) above, content enumerated in Table 8a is correspondingly provided.

TABLE 8a

| seq_est_flag | pic_dest_flag | Semantics |
|---|---|---|
| 0 | X | The EST mode |
| | | and the DEST |
| | | mode are not |
| | | allowed to be used. |
| 1 | 0 | The ST mode |
| | | and the EST |
| | | mode are allowed |
| | | to be used, and |
| | | the DEST mode |
| | | is not allowed |
| | | to be used. |
| 1 | 1 | The ST mode, |
| | | the EST mode, |
| | | and the DEST |
| | | mode are allowed |
| | | to be used. |

In another implementation, if the first syntax element is the slice header syntax element (slice_flag), the second syntax element is the picture header syntax element (pic_flag). The third mode flag included in the first syntax element is denoted as slice_dest_flag, and the second mode flag included in the second syntax element is denoted as pic_est_flag. That slice_dest_flag in the slice header syntax element depends on pic_est_flag in the picture header syntax element may include: decoding of slice_dest_flag depends on pic_est_flag. According to the content described in (II-1) to (II-3) above, content enumerated in Table 8b is correspondingly provided.

TABLE 8b

| pic_est flag | slice_dest_flag | Semantics |
|---|---|---|
| 0 | X | The EST mode |
| | | and the DEST |
| | | mode are not |
| | | allowed to be used. |
| 1 | 0 | The ST mode |
| | | and the EST |
| | | mode are allowed |
| | | to be used, and |
| | | the DEST mode |
| | | is not allowed |
| | | to be used. |
| 1 | 1 | The ST mode, |
| | | the EST mode, |
| | | and the DEST |
| | | mode are allowed |
| | | to be used. |

In still another implementation, if the first syntax element is the slice header syntax element (slice_flag), the second syntax element may alternatively be the sequence header syntax element (seq_flag). The third mode flag included in the first syntax element is denoted as slice_dest_flag, and the second mode flag included in the second syntax element is denoted as seq_est_flag. That slice_dest_flag in the slice header syntax element depends on seq_est_flag in the sequence header syntax element may include: decoding of slice_dest_flag depends on seq_est_flag. According to the content described in (II-1) to (II-3) above, content enumerated in Table 8c is correspondingly provided.

TABLE 8c

| seq_est_flag | slice_dest_flag | Semantics |
|---|---|---|
| 0 | X | The EST mode |
| | | and the DEST |
| | | mode are not |
| | | allowed to be used. |
| 1 | 0 | The ST mode |
| | | and the EST |
| | | mode are allowed |
| | | to be used, and |
| | | the DEST mode |
| | | is not allowed |
| | | to be used. |
| 1 | 1 | The ST mode, |
| | | the EST mode, |
| | | and the DEST |
| | | mode are allowed |
| | | to be used. |

III The second syntax element includes the third mode flag, and that the third mode flag in the first syntax element depends on the third mode flag in the second syntax element may include the following content:

(III-1) If a value of the third mode flag in the second syntax element is a first value, the transform mode syntax control information indicates that the first object is prohibited from using the DEST mode.

For example, if the value of the third mode flag in the second syntax element is the first value (for example, a value “0”), the second syntax element indicates that the second object is prohibited from using the DEST mode. Because the level of the syntax structure corresponding to the second object is higher than the level of the syntax structure corresponding to the first object, when the second object is prohibited from using the DEST mode, the first object cannot use the DEST mode. Therefore, the transform mode syntax control information may indicate that the first object is prohibited from using the DEST mode.

When a syntax element at a higher level prohibits use of the DEST mode, no matter how a mode flag in a syntax element at a lower level is set, a syntax structure at the lower level is not allowed to use the DEST mode. To avoid unnecessary decoding of the third mode flag and save decoding resources, a value of the third mode flag may be set to a target character (for example, a character “x”), so that the transform mode syntax control information may further indicate that the third mode flag does not need to be decoded.

(III-2) If a value of the third mode flag in the second syntax element is a second value, and a value of the third mode flag in the first syntax element is a first value, the transform mode syntax control information indicates that the first object is prohibited from using the DEST mode.

For example, if the value of the third mode flag in the second syntax element is the second value (for example, a value “1”), the second syntax element indicates that the second object is allowed to use the DEST mode. Therefore, when the second object at a higher level is allowed to use the DEST mode, the first object at a lower level may be allowed to use the DEST mode, and whether the first object is allowed to use the DEST mode may be finally determined by using the value of the third mode flag in the first syntax element. In this mode, if the value of the third mode flag in the first syntax element is the first value (for example, a value “0”), the first object is prohibited from using the DEST mode. Therefore, under a joint action of the first syntax element and the second syntax element, the transform mode syntax control information may indicate that the first object is prohibited from using the DEST mode.

(III-3) If a value of the third mode flag in the second syntax element is a second value, and a value of the third mode flag in the first syntax element is the second value, the transform mode syntax control information indicates that the first object is allowed to use the DEST mode.

If the value of the third mode flag in the second syntax element is the second value (for example, a value “1”), the third mode flag in the second syntax element indicates that the second object is allowed to use the DEST mode. This is similar to (III-2) above. If the value of the third mode flag in the first syntax element is the second value (for example, the value “1”), the first object is allowed to use the DEST mode. Therefore, under a joint action of the first syntax element and the second syntax element, the transform mode syntax control information may indicate that the first object is allowed to use the DEST mode.

Based on the content described in (III-1) to (III(3), the following may provide values of corresponding mode flags in different syntax elements and corresponding semantic content that are enumerated in Table 9a, Table 9b, and Table 9c.

In an implementation, if the first syntax element is the picture header syntax element (pic_flag), the second syntax element is the sequence header syntax element (seq_flag). The third mode flag included in the first syntax element is denoted as pic_dest_flag, and the third mode flag included in the second syntax element is denoted as seq_dest_flag. That pic_dest_flag in the picture header syntax element depends on seq_dest_flag in the sequence header syntax element may include: decoding of pic_dest_flag depends on seq_dest_flag. According to the content described in (III-1) to (III-3) above, content enumerated in Table 9a is correspondingly provided.

TABLE 9a

| seq_dest_flag | pic_dest flag | Semantics |
|---|---|---|
| 0 | X | The DEST mode |
| | | is not allowed |
| | | to be used. |
| 1 | 0 | The DEST mode |
| | | is not allowed |
| | | to be used. |
| 1 | 1 | The DEST mode |
| | | is allowed |
| | | to be used. |

For logic of decoding the first syntax element and the second syntax element, refer to content in Table 9a-1 and Table 9a-2.

In the sequence header:

TABLE 9a-1

| | |
|---|---|
| seq_dest_flag | u(1) |

The sequence-header DEST flag (seq_dest_flag) is a binary variable. A value ‘1’ indicates that the DEST mode is allowed to be used. A value ‘0’ indicates that the DEST mode is prohibited from being used. A value of SeqDestFlag is equal to the value of seq_dest_flag. If seq_dest_flag does not exist in the bitstream, the value of SeqDestFlag is 0.

In the picture header:

TABLE 9a-2

| | |
|---|---|
| if(SeqDestFlag) { | |
| pic_dest_flag | u(1) |
| } | |

The picture-header DEST flag (pic_dest_flag) is a binary variable. A value ‘l’ indicates that the DEST mode is allowed to be used. A value ‘0’ indicates that the DEST mode is prohibited from being used. A value of PicDestFlag is equal to the value of pic_dest_flag. If pic_dest_flag does not exist in the bitstream, the value of PicDestFlag is 0.

In another implementation, if the first syntax element is the slice header syntax element (slice_flag), the second syntax element is the picture header syntax element (pic_flag). The third mode flag included in the first syntax element is denoted as slice_dest_flag, and the third mode flag included in the second syntax element is denoted as pic_dest_flag. That slice_dest_flag in the slice header syntax element depends on pic_dest_flag in the picture header syntax element may include: decoding of slice_dest_flag depends on pic_dest_flag. According to the content described in (III-1) to (III-3) above, content enumerated in Table 9b is correspondingly provided.

TABLE 9b

| pic_dest_flag | slice_des_flag | Semantics |
|---|---|---|
| 0 | X | The DEST mode |
| | | is not allowed |
| | | to be used. |
| 1 | 0 | The DEST mode |
| | | is not allowed |
| | | to be used. |
| 1 | 1 | The DEST |
| | | mode is allowed |
| | | to be used. |

For logic of decoding the first syntax element and the second syntax element, refer to content in Table 9b-1 and Table 9b-2:

In the picture header:

TABLE 9b-1

| | |
|---|---|
| pic dest flag | u(1) |

The picture-header DEST flag (pic_dest_flag) is a binary variable. A value ‘1’ indicates that the DEST mode is allowed to be used. A value ‘0’ indicates that the DEST mode is prohibited from being used. A value of PicDestFlag is equal to the value of pic_dest_flag. If pic_dest_flag does not exist in the bitstream, the value of PicDestFlag is 0.

In the slice header:

TABLE 9b-2

| | |
|---|---|
| if(PicDestFlag) { | |
| slice_dest_flag | u(1) |
| } | |

The slice-header DEST flag (slice_dest_flag) is a binary variable. A value ‘1’ indicates that the DEST mode is allowed to be used. A value ‘0’ indicates that the DEST mode is prohibited from being used. A value of SliceDestFlag is equal to the value of slice_dest_flag. If slice_dest_flag does not exist in the bitstream, the value of SliceDestFlag is 0.

In still another implementation, if the first syntax element is the slice header syntax element (slice_flag), the second syntax element may alternatively be the sequence header syntax element (seq_flag). The third mode flag included in the first syntax element is denoted as slice_dest_flag, and the third mode flag included in the second syntax element is denoted as seq_dest_flag. That slice_dest_flag in the slice header syntax element depends on seq_est_flag in the sequence header syntax element may include: decoding of slice_dest_flag depends on seq_est_flag. According to the content described in (III-1) to (III-3) above, content enumerated in Table 9c is correspondingly provided.

TABLE 9c

| seq_dest_flag | slice_dest_flag | Semantics |
|---|---|---|
| 0 | X | The DEST mode |
| | | is not allowed |
| | | to be used. |
| 1 | 0 | The DEST mode |
| | | is not allowed |
| | | to be used. |
| 1 | 1 | The DEST |
| | | mode is allowed |
| | | to be used. |

It can be learned that, in the foregoing several modes I-III, when the first syntax element at the lower level includes only one mode flag, the control of the use of the DEST mode further depends on a value of a mode flag that is in the second syntax element at the higher level and that is configured for controlling the use of the secondary transform mode. According to such a control method, use of the DEST mode by a syntax structure at a lower layer can be controlled by using a syntax element at a higher layer, so that whether to use the DEST mode can be determined when a small amount of content is obtained through decoding. This is beneficial to improving coding performance.

S302: Decode the coded bitstream. In an example, a current block of a current picture of the video is decoded with the secondary transform mode that is determined based on the transform mode syntax control information. The transform mode syntax control information indicates which of the plurality of secondary transform modes is enabled for the current block.

In an example of an implementation, a process of decoding the coded bitstream includes: first performing entropy decoding on the coded bitstream to obtain various mode information (for example, a prediction mode) and quantized transform coefficients used in a coding process; sequentially performing scaling & an inv. transform on the quantized transform coefficients to obtain residual data, and determining the prediction mode according to the mode information to perform prediction, to obtain predicted data; and obtaining reconstructed data according to the residual data and the predicted data. An inverse transform process involves use of some transform modes. Therefore, at this stage, the transform mode syntax control information in the coded bitstream may be applied to determine which types of transform modes are to be used.

S303: Control the use of the transform mode according to the transform mode syntax control information in the decoding process.

In an example of an implementation, because there are multiple types of transform modes, a transform mode that is allowed to be used may be determined according to transform mode syntax control information in the decoding process, and a transform is performed on the current object according to the determined transform mode. For example, the transform mode includes the secondary transform mode. If the transform mode syntax control information indicates that the DEST mode is allowed to be used, an intra CU may use the DEST mode.

The following implementations are described on the premise that the transform mode includes the secondary transform mode and the transform mode syntax control information is configured for controlling the use of the secondary transform mode.

In an implementation, the secondary transform mode includes, but is not limited to, the ST mode, the EST mode, and the DEST mode. If the transform mode syntax control information includes one syntax element, for example, includes only the sequence header syntax element, the picture header syntax element, or the slice header syntax element, in a process of controlling the use of the secondary transform mode according to the transform mode syntax control information, use of the secondary transform mode by a syntax structure on which the syntax element functions and a syntax structure at a lower level than the syntax structure may be controlled based on an indication of the syntax element. For example, the transform mode syntax control information includes only the sequence header syntax element, and the sequence header syntax element indicates that the current video sequence is allowed to use the ST mode, the EST mode, and the DEST mode. In this case, a picture, a slice, a CU, and a TU are all allowed to use the ST mode, the EST mode, and the DEST mode. In a mode, although these secondary transform modes are allowed to be used, whether the secondary transform modes are actually to be used in the decoding process may be further determined with reference to other information of the current object that is being decoded.

In another implementation, if the transform mode syntax control information includes multiple syntax elements, based on dependency between the syntax elements and using an example in which the transform mode syntax control information includes the first syntax element and the second syntax element, the consumer device may perform operation 1.1 to operation 1.3 when performing S303.

Operation 1.1: Compare a level of a first syntax structure on which the first syntax element functions with a level of a second syntax structure on which the second syntax element functions.

For example, a syntax structure on which each syntax element functions is a syntax structure corresponding to a current object involved when the syntax element controls the secondary transform mode. For example, the first syntax element is the picture header syntax element, and indicates use of the secondary transform mode by the current picture, and a syntax structure corresponding to the current picture is a picture. Therefore, the first syntax structure is the picture. The second syntax element is the sequence header syntax element, and indicates use of the secondary transform mode by the current video sequence, and a syntax structure corresponding to the current video sequence is a video sequence. Therefore, the second syntax structure is the video sequence.

The consumer device may compare the levels of the first syntax structure and the second syntax structure, to determine a syntax structure at a higher level. For example, the first syntax structure is the image, the second syntax structure is the video sequence, and it may be determined through comparison of the levels of the syntax structures that the second syntax structure is the syntax structure at the higher layer. Based on the control, of the use of the secondary transform mode, by the syntax element corresponding to the syntax structure at the higher level, decoding of the syntax element corresponding to the syntax structure at the lower level is determined, or the use of the secondary transform mode is controlled according to the syntax element corresponding to the syntax structure at the lower level. Refer to content described in operation 1.2 and operation 1.3.

Operation 1.2: If the syntax element corresponding to the syntax structure at the higher level in the first syntax structure and the second syntax structure indicates that the secondary transform mode is prohibited from being used, the syntax element corresponding to the syntax structure at the lower level in the first syntax structure and the second syntax structure does not need to be decoded.

In an example of an implementation, if the level of the first syntax structure is higher than the level of the second syntax structure, the first syntax structure is the syntax structure at the higher level, the first syntax element is the syntax element corresponding to the syntax structure at the higher level, and the second syntax element is the syntax element corresponding to the syntax structure at the lower level. If the level of the second syntax structure is higher than the level of the first syntax structure, the second syntax structure is the syntax structure at the higher level, the second syntax element is the syntax element corresponding to the syntax structure at the higher level, and the first syntax element is the syntax element corresponding to the syntax structure at the lower level.

When the syntax element corresponding to the syntax structure at the higher level indicates that the secondary transform mode (for example, the DEST mode) is prohibited from being used, based on a dependency relationship between syntax elements corresponding to different syntax structures, the syntax element corresponding to the syntax structure at the lower level does not need to be decoded. For example, the first syntax element is the picture header syntax element (pic_flag), and the second syntax element is the sequence header syntax element (seq_flag). When the sequence header syntax element indicates that the DEST mode is prohibited from being used, the picture header syntax element does not need to be decoded.

Operation 1.3: If the syntax element corresponding to the syntax structure at the higher level in the first syntax structure and the second syntax structure indicates that the secondary transform mode is allowed to be used, control the use of the secondary transform mode according to the syntax element corresponding to the syntax structure at the lower level in the first syntax structure and the second syntax structure.

In an example of an implementation, when the syntax element corresponding to the syntax structure at the higher level indicates that the secondary transform mode (for example, the DEST mode) is allowed to be used, the syntax element corresponding to the syntax structure at the lower level may be obtained through decoding, to control the use of the secondary transform mode according to the syntax element corresponding to the syntax structure at the lower level. The syntax element corresponding to the syntax structure at the lower level may indicate a type of secondary transform mode that is allowed to be used and/or a type of secondary transform mode that is prohibited from being used. For the indication of the syntax element, refer to various feasible implementations of the target syntax element above. Details are not described herein again. For example, the first syntax element is the picture header syntax element (pic_flag), and the second syntax element is the sequence header syntax element. When the sequence header syntax element indicates that the DEST mode is allowed to be used, the picture header syntax element may be obtained through decoding. When the picture header syntax element indicates that the DEST mode is allowed to be used, a secondary transform may be performed in the DEST mode.

It can be learned that when the syntax element corresponding to the syntax structure at the higher level indicates that the secondary transform mode (for example, the DEST mode) is prohibited from being used, the syntax element corresponding to the syntax structure at the lower level does not need to be decoded, and the syntax structure at the lower level does not use the secondary transform mode. If the syntax element corresponding to the syntax structure at the higher level indicates that the secondary transform mode is allowed to be used, which types of secondary transform modes are to be used may be determined based on a value of a mode flag included in the syntax element at the lower level. For example, if the sequence header syntax element indicates that the DEST mode is allowed to be used, the picture header syntax element may be decoded, and it is determined, based on the decoded picture header syntax element, that the picture is to use the DEST mode.

If the transform mode syntax control information includes more than two syntax elements, levels of syntax structures on which the syntax elements function may be sorted in descending order, so that: (i) When a syntax element at a higher syntax level indicates that the secondary transform mode is prohibited from being used, a syntax element at a lower syntax level than the syntax element does not need to be decoded. For example, the transform mode syntax control information includes: the sequence header syntax element, the picture header syntax element, and the slice header syntax element. A syntax element at a highest level is the sequence header syntax element, and the sequence header syntax element indicates that the DEST mode is not allowed to be used. Therefore, the picture header syntax element, the slice header syntax element, and the like do not need to be decoded, and it may be determined that the picture and the slice do not use the DEST mode. If the sequence header syntax element indicates that the DEST mode is allowed to be used, the picture header syntax element may be obtained through decoding. If the picture header syntax element indicates that the DEST mode is not allowed to be used, the slice header syntax element does not need to be decoded. (ii) When a syntax element at a higher syntax level indicates that the secondary transform mode is prohibited from being used, use of the secondary transform mode may be controlled according to a syntax element at a lower level. Still using the foregoing example, when the sequence header syntax element indicates that the DEST mode is allowed to be used, the picture header syntax element may be obtained through decoding, and use of the DEST mode is controlled according to the picture header syntax element. For example, if the picture header syntax element indicates that the DEST mode is allowed to be used, the slice header syntax element may be obtained through decoding, and use of the DEST mode is controlled according to the slice header syntax element.

In some examples, the content described in operation 1.2 and operation 1.3 is set based on a decoding order of the syntax structures in the coded bitstream and function priorities of the syntax elements. The syntax elements that are set in the syntax structures have decoding priorities based on the decoding order of the corresponding syntax structures in the coded bitstream, where the decoding priorities are: the sequence header>the picture header>the slice header>the CU>the TU. When a syntax element with a higher decoding priority indicates that the secondary transform mode (for example, the DEST mode) is not allowed to be used, a syntax element at a next layer that is related to the secondary transform mode (for example, the DEST mode) does not need to be obtained through decoding. The function priorities of the syntax elements are the TU>the CU>the slice header>the picture header>the sequence header. When a syntax element with a higher function priority indicates that the secondary transform mode (for example, the DEST mode) is not allowed to be used, even if a syntax element with a lower function priority indicates that the secondary transform mode (for example, the DEST mode) is allowed to be used, the secondary transform mode (for example, the DEST mode) is not to be used. The secondary transform mode can be controlled at a higher layer through such setting, so that unnecessary decoding can be reduced, thereby improving decoding efficiency.

In an aspect, the transform mode includes the secondary transform mode, and the transform mode syntax control information is configured for controlling the use of the secondary transform mode. Based on this, the consumer device may further perform operation 2.1 to operation 2.3.

Operation 2.1: Determine the current picture in the coded bitstream in the decoding process, where the current picture is a picture being decoded.

Operation 2.2: Obtain a picture type of the current picture.

Operation 2.3: If the picture type of the current picture is an I frame, trigger execution of the operation of controlling the use of the transform mode according to the transform mode syntax control information.

In an example of an implementation, the video sequence may be first decoded based on the decoding order of the coded bitstream. The video sequence includes multiple frames of pictures, and a frame of picture being decoded is the current picture. Each frame of picture belongs to one picture type, and the picture type may include the I frame, a B frame, and a P frame. The picture type of the current picture may be one of the I frame, the B frame, and the P frame. For example, the picture type of the current picture is the I frame. Because intra prediction is performed on the I frame, and the secondary transform mode is applied to an intra predicted frame, better coding performance can be achieved. Therefore, when the picture type of the current picture is the I frame or another type of picture, whether to use the secondary transform mode may be determined.

(i) If the picture type of the current picture is the I frame, the current picture uses an intra prediction mode. In this case, the use of the secondary transform mode may be controlled according to the transform mode syntax control information. The transform mode syntax control information may be decoded to obtain the syntax element included in the transform mode syntax control information, and a secondary transform is performed on the current picture in a secondary transform mode that is allowed to be used and that is indicated by the syntax element. For example, the secondary transform is performed on the current picture in the DEST mode. (ii) If the picture type of the current picture is the P frame or the B frame, because the P frame and the B frame usually undergo prediction in an inter prediction mode, and are not suitable for the secondary transform mode, a secondary transform does not need to be performed, the execution of the operation of controlling the use of the transform mode according to the transform mode syntax control information does not need to be triggered, and the transform mode syntax control information does not need to be obtained through decoding to control the use of the secondary transform mode.

In operation 2.1 to operation 2.3, whether to decode and use the transform mode syntax control information is determined according to the picture type. For example, the transform mode syntax control information configured for controlling the use of the secondary transform mode is decoded only in the I frame, to perform the corresponding secondary transform. For example, the syntax element dest_flag indicating the use of the DEST mode needs to be decoded only in the I frame.

In an aspect, the transform mode includes the secondary transform mode, and the transform mode syntax control information is configured for controlling the use of the secondary transform mode. Based on this, when controlling the use of the transform mode according to the transform mode syntax control information, the consumer device may execute the following content: If the transform mode syntax control information indicates that the current object is allowed to use the DEST mode, (i) determining the DEST mode as a target secondary transform mode that needs to be used by the current object; or (ii) determining, according to reference information of the current object, a target secondary transform mode that needs to be used by the current object, where the current object is a TU or CU that is being decoded in the coded bitstream.

In other words, whether the current object is to use the DEST mode may be determined according to the transform mode syntax control information. Because the transform mode syntax control information is high-layer syntax information configured for controlling the use of the secondary transform mode, the transform mode syntax control information may be configured for controlling the use of the secondary transform mode by the video sequence, the picture, or the slice. There is transitivity of controlling the use of the secondary transform mode between different syntax structures. The transitivity means: When a syntax structure at a higher level is allowed to use the secondary transform mode, use of the secondary transform mode by a syntax structure at a lower level may be flexibly controlled by a syntax element corresponding to the syntax structure. When a syntax structure at a higher level is not allowed to use the secondary transform mode, a syntax structure at a lower level is not allowed to use the secondary transform mode either. Based on the transitivity, whether the syntax structure at the higher level is allowed to use the ST mode, the EST mode, and the DEST mode may directly affect use of the DEST mode by the CU and the TU. For example, if the transform mode syntax control information indicates that the current picture or the current slice is allowed to use the DEST mode, it may be determined that the current object (for example, a current CU or a current TU) is allowed to use the DEST mode. If the current picture is not allowed to use the ST mode or the DEST mode, it may be determined that the current object (for example, a current CU or a current TU) is not allowed to use the DEST mode.

When the current object is determined to be allowed to use the DEST mode, in an implementation, the DEST mode may be directly determined as the target secondary transform mode that needs to be used by the current object, so that DEST-related processing may be performed on the current object in the DEST mode. For the DEST-related processing, refer to the content described in the foregoing descriptions of the DEST mode, and details are not described herein again.

If the transform mode syntax control information indicates that the DEST mode is prohibited from being used, the DEST-related processing does not need to be performed on the current object. In addition, if the current object includes control information indicating the use of the DEST mode, the control information does not need to be obtained through decoding. For example, if a corresponding flag exists in the current object to explicitly indicate that the DEST mode is allowed to be used, the flag is not decoded in an actual processing process, and therefore a secondary transform does not need to be performed on the current object.

In another implementation, the target secondary transform mode that needs to be used by the current object may be determined according to the reference information of the current object, to further determine whether to perform DEST-related processing. If it is determined, according to the reference information of the current object, that the DEST mode is the target secondary transform mode that needs to be used, the DEST-related processing may be performed on the current object. If it is determined, according to the reference information of the current object, that the DEST mode is not the target secondary transform mode that needs to be used, the DEST-related processing is not performed on the current object.

The reference information of the current object may be some attribute information of the current object. In some aspects, the reference information includes at least one of the following: the size of the current object, a prediction mode used by the current object, or a partition mode used by the current object. When the target secondary transform mode that needs to be used by the current object is determined according to the reference information, any one of (i) to (iii) may be included:

(i) If the size of the current object falls within a preset size range, the DEST mode is determined as the target secondary transform mode that needs to be used by the current object.

For example, the preset size range is a size range supported by the DEST mode. The size includes the width and the height, and the falling within the preset size range means that the width falls within a preset width range and the height falls within a preset height range. For example, the preset size range is from 4×4 to 64×64. If the size of the current object is 8×8, because the width being 8 falls within the preset width range [4, 64], and the height being 8 falls within the preset height range [4, 64], the current object can use the DEST mode, so that the DEST mode may be determined as the needed target secondary transform mode, to perform a secondary transform on the current object in the DEST mode. On the contrary, if the size of the current object does not fall within the preset size range, for example, the width does not fall within the preset width range or the height does not fall within the preset height range, it may be determined that the current object is not to use the DEST mode, and the DEST-related processing is not performed on the current object.

(ii) If the prediction mode used by the current object is a specified type (or a predefined type) of intra prediction mode, the DEST mode is determined as the target secondary transform mode that needs to be used by the current object.

There are multiple types of intra prediction modes, for example, a DC mode (applicable to a large-area flat region), an angular prediction mode, and a plane mode (including horizontal prediction and vertical prediction). There may be one or more specified types of intra prediction modes, and one or more types of intra prediction modes may be selected from the multiple types of intra prediction modes as the specified type of intra prediction mode. For example, the DC mode and the angular prediction mode are used as specified types of intra prediction modes.

If the intra prediction mode used by the current object is the specified type of intra prediction mode, intra prediction is performed on the current object, so that the DEST mode can be determined as the target secondary transform mode that needs to be used by the current object. On the contrary, if the prediction mode used by the current object is another type of intra prediction mode (for example, an intra prediction mode other than the specified type of intra prediction mode in the multiple types of intra prediction modes) or an inter prediction mode, it may be determined that the current object is not to use the DEST mode.

(iii) If the partition mode used by the current object is a non-DT partition mode, the DEST mode is determined as the target secondary transform mode that needs to be used by the current object.

Because the ST mode and the like may be applied to a non-DT intra-coded CU, when the partition mode used by the current object is the non-DT partition mode, the DEST mode may be applied to the current object, in other words, the target secondary transform mode that needs to be used by the current object is the DEST mode. On the contrary, if the partition mode used by the current object is DT partition, it may be determined that the current object is not to use the DEST mode.

In an aspect, the transform mode syntax control information is further configured for controlling use of transform information needed by the transform mode. The transform mode herein not only includes the secondary transform mode, but also includes other transform modes, including but not limited to, the PBT mode and the SBT mode. In other words, the transform mode syntax control information not only indicates use of transform information needed by the secondary transform mode, but also may indicate use of transform information needed by the other transform modes. The transform information includes one or both of a transform kernel and a transform type. The transform kernel herein includes a separable transform kernel and an inseparable transform kernel. For example, a DCT-II and a DST-VII are separable transform kernels.

For example, the transform mode syntax control information may indicate a specific transform kernel of the DEST mode that is to be used or a specific transform kernel of the ST mode that is to be used, for example, an ST transform kernel having a size of 8×8. The transform mode syntax control information may further indicate a DEST transform type (for example, horizontal flipping, vertical flipping, or diagonal flipping) that needs to be used. For another example, because transform types allowed by the PBT mode include a DCT8 and a DST7, the transform mode syntax control information may further indicate to use one or both of the DCT8 and DST7 in the PBT mode. Transform types allowed by the SBT mode include the DCT8, the DST7, and the DCT-2. The transform mode syntax control information may further indicate to use one or more of the DCT8, the DST7, and the DCT-2 in the SBT mode. Based on the information that is for the transform mode and that is controlled by the transform mode syntax control information, one or more of the following may be determined according to the transform mode syntax control information: the ST transform kernel that needs to be used, the DEST transform kernel that needs to be used, the DEST transform type that needs to be used, an SBT transform type that needs to be used, a PBT transform type that needs to be used, and the like.

According to the data processing method provided in this aspect of this disclosure, the coded bitstream is decoded, so that the use of the transform mode, including the secondary transform mode, the PBT mode, the SBT mode, and the like, can be flexibly controlled based on the transform mode syntax control information in the decoding process. The decoding process can be more efficient through flexible control on the transform mode, thereby improving the decoding efficiency. In an example of an implementation, control information such as a syntax element is mainly added to a syntax structure at a higher layer to control use of various types of secondary transform modes, and rich control modes are designed based on different numbers of mode flags included in the syntax element, thereby further improving flexibility in controlling the use of the secondary transform mode.

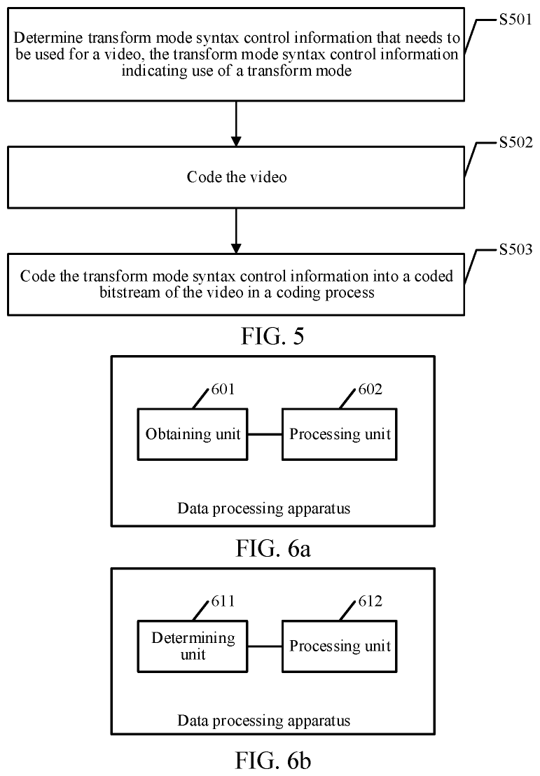

FIG. 5 is a schematic flowchart of a data processing method according to an aspect of this disclosure. The data processing method may be performed by the service device 201 in the data processing system. The method includes the following operations S501 to S503.

S501: Determine transform mode syntax control information that needs to be used for a video, the transform mode syntax control information indicating use of a transform mode. For example, a secondary transform mode is determined from a plurality of secondary transform modes based on the transform mode syntax control information.

In an implementation, the service device may obtain the video, and determine the transform mode syntax control information for the video. The transform mode includes, but is not limited to, a PBT mode, an SBT mode, and a secondary transform mode. For example, when a type of the video is a screen content video, the transform mode syntax control information may be set, and the transform mode syntax control information may be configured for flexibly controlling enabling and disabling of the secondary transform mode in higher-layer syntax structures of a sequence level, a picture level, and the like. For example, an intra predicted frame is allowed to use a DEST mode, and an inter predicted frame is prohibited from using the DEST mode.

S502: Code the video. In an example, a current block of a current picture of the video is coded with the secondary transform mode that is determined based on the transform mode syntax control information. The transform mode syntax control information indicates which of the plurality of secondary transform modes is enabled for the current block.

The service device may code the video. For an example of a coding process, refer to FIG. 1a. In a coding process, based on setting of the transform mode syntax control information, if the transform mode syntax control information is configured for controlling the secondary transform mode, a corresponding type of secondary transform mode (for example, the DEST mode) that needs to be used by a CU may be determined based on an indication of the transform mode syntax control information at a transform stage, so that a secondary transform is performed on the CU according to the determined corresponding type of secondary transform mode.

S503: Code the transform mode syntax control information into a coded bitstream of the video in the coding process.

In an implementation, the transform mode includes the secondary transform mode, and the transform mode syntax control information includes multiple syntax elements. When coding the transform mode syntax control information into the coded bitstream of the video, the service device may, for example, determine a syntax structure (for example, a sequence, a picture, or a slice) of a current coding object (for example, an object that is being coded), and add a syntax element to the corresponding syntax structure, so that the syntax element in the transform mode syntax control information is set to the correct syntax structure. For example, the service device may add a sequence header syntax element to a sequence header, add a picture header syntax element to a picture header, and add a slice header syntax element to a slice header. The transform mode syntax control information is coded into the coded bitstream, so that the coded bitstream including the transform mode syntax control information can be obtained, to help a decoder side control the use of the transform mode based on the transform mode syntax control information.

In the data processing method provided in this aspect of this disclosure, the transform mode syntax control information is determined for the video, and the transform mode syntax control information is coded into the coded bitstream, to accurately indicate the use of the transform mode to the decoder side. In addition, the transform mode syntax control information is set in consideration of a corresponding scenario of the video, so that the use of the transform mode can be adaptively controlled based on different scenarios, thereby improving coding performance.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

FIG. 6a is a schematic diagram of a structure of a data processing apparatus according to an aspect of this disclosure. The data processing apparatus may be disposed in a consumer device provided in the aspects of this disclosure, and the consumer device may be the consumer device in the foregoing method aspects. The data processing apparatus shown in FIG. 6a may be a computer program (including program code) running in the consumer device. The data processing apparatus may be configured to perform some or all operations in the method aspects shown in FIG. 3. Refer to FIG. 6a. The data processing apparatus may include the following units:
an obtaining unit 601, configured to obtain a coded bitstream of a video, the coded bitstream including transform mode syntax control information, and the transform mode syntax control information being configured for controlling use of a transform mode; and
a processing unit 602, configured to decode the coded bitstream.

The processing unit 602 is further configured to control the use of the transform mode according to the transform mode syntax control information in a decoding process.

FIG. 6b is a schematic diagram of a structure of another data processing apparatus according to an aspect of this disclosure. The data processing apparatus may be disposed in a service device provided in the aspects of this disclosure, and the service device may be the service device in the foregoing method aspects. The data processing apparatus shown in FIG. 6b may be a computer program (including program code) running in the service device. The data processing apparatus may be configured to perform some or all operations in the method aspects shown in FIG. 5. Refer to FIG. 6b. The data processing apparatus may include the following units:
a determining unit 611, configured to determine transform mode syntax control information that needs to be used for a video, the transform mode syntax control information being configured for controlling use of a transform mode; and
a processing unit 612, configured to code the video.

The processing unit 612 is configured to code the transform mode syntax control information into a coded bitstream of the video in a coding process.

Examples of functions of the units of the data processing apparatuses described in the aspects of this disclosure may be implemented according to the methods in the foregoing method aspects. For examples of implementation processes thereof, refer to the related descriptions in the foregoing method aspects, and details are not described herein again. In addition, descriptions of beneficial effects achieved by using the same method are not described again.

Next, the consumer device and the service device provided in the aspects of this disclosure are described.

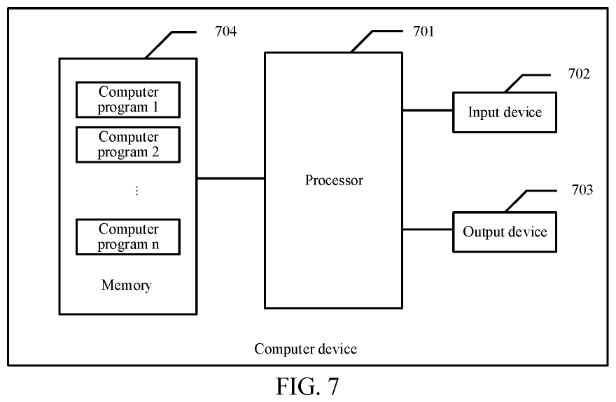

An aspect of this disclosure further provides a schematic diagram of a structure of a computer device. For the schematic diagram of the structure of the computer device, refer to FIG. 7. The computer device may include processing circuitry (for example, a processor 701), an input device 702, an output device 703, and a memory 704. The processing circuitry (for example, the processor 701), the input device 702, the output device 703, and the memory 704 are connected through a bus. The memory 704 is configured to store a computer program. The computer program includes program instructions. The processing circuitry (for example, the processor 701) is configured to execute the program instructions stored in the memory 704.

In an aspect, the computer device may be the consumer device; and in this aspect, the processor 701 performs the following operations by running executable program code in the memory 704:
obtaining a coded bitstream of a video, the coded bitstream including transform mode syntax control information, and the transform mode syntax control information being configured for controlling use of a transform mode;
decoding the coded bitstream; and
controlling the use of the transform mode according to the transform mode syntax control information in a decoding process.

In another aspect, the computer device may be the service device; and in this aspect, the processor 701 performs the following operations by running executable program code in the memory 704:
determining transform mode syntax control information that needs to be used for a video, the transform mode syntax control information being configured for controlling use of a transform mode;
coding the video; and
coding the transform mode syntax control information into a coded bitstream of the video in a coding process.

The computer device described in this aspect of this disclosure may implement the descriptions of the data processing method in the foregoing corresponding aspects, or may implement the descriptions of the data processing apparatus in the foregoing corresponding aspects. Details are not described herein again. In addition, descriptions of beneficial effects achieved by using the same method are not described again.

In addition, an aspect of this disclosure further provides a computer-readable storage medium (for example, a non-transitory computer-readable storage medium). The computer-readable storage medium stores a computer program, and the computer program includes program instructions. When executing the program instructions, a processor can perform the methods in the aspects corresponding to FIG. 3 and FIG. 5. Therefore, details are not described herein again.

According to an aspect of this disclosure, a computer program product is provided. The computer program product includes a computer program, and the computer program is stored in a computer-readable storage medium (for example, a non-transitory computer-readable storage medium). Processing circuitry (for example, a processor) of a computer device reads the computer program from the computer-readable storage medium and executes the computer program, to cause the computer device to perform the methods in the aspects corresponding to FIG. 3 and FIG. 5. Therefore, details are not described herein again.

An aspect of this disclosure provides a method for processing a video bitstream. The video bitstream is generated according to the data processing method in the aspect corresponding to FIG. 3, or is decoded according to the data processing method in the aspect corresponding to FIG. 5.

An aspect of this disclosure further provides a computer-readable storage medium (for example, a non-transitory computer-readable storage medium). The computer-readable storage medium stores a video bitstream formed by a computer program. When the computer program is executed by a processor, the methods in the aspects corresponding to FIG. 3 and FIG. 5 can be performed. Therefore, this is not described herein again.

A person of ordinary skill in the art may understand that all or some of the procedures of the methods in the foregoing aspects may be implemented by a computer program instructing relevant hardware. The computer program may be stored in a computer-readable storage medium (for example, a non-transitory computer-readable storage medium). When the program is executed, the procedures in the foregoing method aspects may be performed. The storage medium may include a magnetic disc, an optical disc, a read-only memory (ROM), a random access memory (RAM), or the like.

The aspects disclosed above are merely non-limiting aspects of this disclosure, and are not intended to limit the scope of claims of this disclosure. A person of ordinary skill in the art can understand all or some of the procedures for implementing the foregoing aspects. Any equivalent variations made based on the claims of this disclosure shall fall within the scope of this disclosure.

What is claimed is:

1. A video decoding method, comprising:
obtaining a coded bitstream of a video, the coded bitstream including transform mode syntax control information of a secondary transform mode;
determining the secondary transform mode from a plurality of secondary transform modes based on the transform mode syntax control information; and
decoding a current block of a current picture of the video with the secondary transform mode that is determined based on the transform mode syntax control information,
wherein the transform mode syntax control information indicates which of the plurality of secondary transform modes is enabled for the current block.

2. The method according to claim 1, wherein the transform mode syntax control information is associated with a video sequence, a picture, a slice, a coding unit (CU), or a transform unit (TU).

3. The method according to claim 2, wherein
when the transform mode syntax control information is associated with the video sequence, the transform mode syntax control information is set in a sequence header of a current video sequence and is a sequence header syntax element, and the secondary transform mode for the current video sequence is determined based on the sequence header syntax element;
when the transform mode syntax control information is associated with the picture, the transform mode syntax control information is set in a picture header of a current picture and is a picture header syntax element, and the secondary transform mode for the current picture is determined based on the transform mode syntax control information; and
when the transform mode syntax control information is associated with the slice, the transform mode syntax control information is set in a slice header of a current slice and is a slice header syntax element, the secondary transform mode for the current slice is determined based on the transform mode syntax control information.

4. The method according to claim 1, wherein the plurality of secondary transform modes includes a secondary transform (ST) mode, an enhanced secondary transform (EST) mode, and a decoder-side enhanced secondary transform (DEST) mode.

5. The method according to claim 4, wherein
when a value of a first mode flag included in the transform mode syntax control information is a first value, the transform mode syntax control information indicates that the ST mode, the EST mode, and the DEST mode are prohibited for the current block;
when the value of the first mode flag is a second value, the transform mode syntax control information indicates that the ST mode is allowed for the current block and both the EST mode and the DEST mode are prohibited for the current block;
when the value of the first mode flag is a third value, the transform mode syntax control information indicates that both the ST mode and the EST mode are allowed for the current block and the DEST mode is prohibited for the current block; and
when the value of the first mode flag is a fourth value, the transform mode syntax control information indicates that the ST mode, the EST mode, and the DEST mode are allowed for the current block.

6. The method according to claim 4, wherein the transform mode syntax control information includes a reference mode flag and a third mode flag, and wherein
when a value of the reference mode flag is a first value, the transform mode syntax control information indicates that the ST mode, the EST mode, and the DEST mode are prohibited for the current block;
when the value of the reference mode flag is a second value, and a value of the third mode flag is the first value, the transform mode syntax control information indicates that both the ST mode and the EST mode are allowed for the current block and the DEST mode is prohibited for the current block; and
when the value of the reference mode flag is the second value, and the value of the third mode flag is the second value, the transform mode syntax control information indicates that the ST mode, the EST mode, and the DEST mode are allowed for the current block.

7. The method according to claim 4, wherein
the transform mode syntax control information includes a first mode flag, a second mode flag, and a third mode flag;
when a value of the first mode flag is a first value, the transform mode syntax control information indicates that the ST mode, the EST mode, and the DEST mode are prohibited for the current block;
when the value of the first mode flag is a second value, and a value of the second mode flag is the first value, the transform mode syntax control information indicates that the ST mode is allowed for the current block and both the EST mode and the DEST mode are prohibited for the current block;
when the values of both the first mode flag and the second mode flag are the second value, and a value of the third mode flag is the first value, the transform mode syntax control information indicates that both the ST mode and the EST mode are allowed for the current block and the DEST mode is prohibited for the current block; and
when the values of both the first mode flag and the second mode flag are the second value, and the value of the third mode flag is the second value, the transform mode syntax control information indicates that the ST mode, the EST mode, and the DEST mode are allowed for the current block.

8. The method according to claim 4, wherein
the transform mode syntax control information includes a first syntax element and a second syntax element;
a level of a syntax structure corresponding to the second syntax element is higher than a level of a syntax structure corresponding to the first syntax element;
the first syntax element includes a mode flag that indicates use of the DEST mode; and
the second syntax element includes one or more of a first mode flag, a second mode flag, and a third mode flag, the first mode flag in the second syntax element indicating use of the ST mode, the second mode flag in the second syntax element indicating use of the EST mode, and the third mode flag in the second syntax element indicating use of the DEST mode.

9. The method according to claim 8, wherein
when a value of the first mode flag included in the second syntax element is a first value, the transform mode syntax control information indicates that the ST mode, the EST mode, and the DEST mode are prohibited for a first block associated with the first syntax element;
when the value of the first mode flag in the second syntax element is a second value, and a value of the mode flag in the first syntax element is the first value, the transform mode syntax control information indicates that both the ST mode and the EST mode are allowed for the first block and the DEST is prohibited for the first block; and
when the value of the first mode flag in the second syntax element is the second value, and the value of the mode flag in the first syntax element is the second value, the transform mode syntax control information indicates that the ST mode, the EST mode, and the DEST mode are allowed for the first block.

10. The method according to claim 8, wherein
when a value of the second mode flag included in the second syntax element is a first value, the transform mode syntax control information indicates that the EST mode and the DEST mode are prohibited for a first block associated with the first syntax element;
when the value of the second mode flag in the second syntax element is a second value, and a value of the mode flag in the first syntax element is the first value, the transform mode syntax control information indicates that both the ST mode and the EST mode are allowed for the first block and the DEST mode is prohibited for the first block; and
when the value of the second mode flag in the second syntax element is the second value, and the value of the mode flag in the first syntax element is the second value, the transform mode syntax control information indicates that the ST mode, the EST mode, and the DEST mode are allowed for the first block.

11. The method according to claim 8, wherein
when a value of the third mode flag included in the second syntax element is a first value, the transform mode syntax control information indicates that the DEST mode is prohibited for a first block associated with the first syntax element;
when a value of the third mode flag in the second syntax element is a second value, and a value of the mode flag in the first syntax element is the first value, the transform mode syntax control information indicates that the DEST mode is prohibited for the first block; and
when the value of the third mode flag in the second syntax element is the second value, and the value of the mode flag in the first syntax element is the second value, the transform mode syntax control information indicates that the DEST mode is allowed for the first block.

12. The method according to claim 1, further comprising:
decoding the current picture from the coded bitstream;
obtaining a picture type of the current picture; and
when the picture type of the current picture is an I-frame picture, determining that the current block is decoded with the secondary transform mode determined based on the transform mode syntax control information.

13. The method according to claim 4, further comprising:
when the transform mode syntax control information indicates that the DEST mode is allowed for the current block,
determining the DEST mode as a target secondary transform mode of the current block; or
determining, based on reference information of the current block, the target secondary transform mode of the current block.

14. The method according to claim 13, wherein the reference information includes at least one of a size of the current block, a prediction mode of the current block, or a partition mode of the current block; and the determining comprises determining the DEST mode as the target secondary transform mode of the current block, when the size of the current block falls within a preset size range, when the prediction mode of the current block is a predefined type of intra prediction mode, or when the partition mode of the current block is a non-derived tree (DT) partition mode.

15. The method according to claim 1, wherein the transform mode syntax control information comprises a first syntax element and a second syntax element; and the decoding comprises:
comparing a syntax structure level of the first syntax element with a syntax structure level of the second syntax element;
when one of the first syntax element and the second syntax element at a higher syntax structure level indicates that the secondary transform mode is prohibited from being used, determining that another of the first syntax element and the second syntax element at a lower syntax structure level is not to be decoded; and
when the one of the first syntax element and the second syntax element at the higher syntax structure level indicates that the secondary transform mode is allowed to be used, decoding the current block with the secondary transform mode based on another of the first syntax element and the second syntax element at the lower syntax structure level.

16. The method according to claim 1, wherein
the transform mode syntax control information indicates use of transform information of a transform mode;
the transform mode includes at least one of the secondary transform mode, a position based transform (PBT) mode, or a sub-block transform (SBT) mode; and
the transform information includes at least one of a transform kernel or a transform type.

17. A video encoding method, comprising:
determining a secondary transform mode from a plurality of secondary transform mode;
generating transform mode syntax control information of a video that indicates the secondary transform mode;
encoding a current block of a current picture of the video with the secondary transform mode; and
encoding the transform mode syntax control information into a coded bitstream of the video,
wherein the transform mode syntax control information indicates which of the plurality of secondary transform modes is enabled for the current block.

18. The method according to claim 17, wherein the transform mode syntax control information is associated with a video sequence, a picture, a slice, a coding unit (CU), or a transform unit (TU).

19. A video decoding apparatus, comprising:
processing circuitry configured to:
obtain a coded bitstream of a video, the coded bitstream including transform mode syntax control information of a secondary transform mode;
determine the secondary transform mode from a plurality of secondary transform modes based on the transform mode syntax control information; and
decode a current block of a current picture of the video with the secondary transform mode that is determined based on the transform mode syntax control information,
wherein the transform mode syntax control information indicates which of the plurality of secondary transform modes is enabled for the current block.

20. The apparatus according to claim 19, wherein the transform mode syntax control information is associated with a video sequence, a picture, a slice, a coding unit (CU), or a transform unit (TU).
